(19) United States
(12) Patent Application Publication
(10) Pub. No.: US 2006/0114750 A1
(43) Pub. Date: Jun. 1, 2006

(54) Electronic apparatus, method for detecting positions of time display members in electronic apparatus, and program for detecting positions of time display members in electronic apparatus

(75) Inventors: Kenji Iida, Shiojiri-shi (JP); Fumiaki Miyahara, Shiojiri-shi (JP); Kunio Koike, Matsumoto-shi (JP); Eisaku Shimizu, Okaya-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/287,301

(22) Filed: Nov. 28, 2005

(30) Foreign Application Priority Data
Nov. 29, 2004 (JP) JP2004-344502
Nov. 29, 2004 (JP) JP2004-344685

(51) Int. Cl. G04B 19/30

(52) U.S. Cl. 368/67

(57) ABSTRACT

A timepiece includes pointers, motors for driving the pointers, a pointer position detector for detecting the positions of the pointers, a control unit, an electricity storage unit as a power supply, and a voltage detector for detecting the power supply voltage. The control unit controls the pointer position detection by means of the pointer position detector on the basis of the power supply voltage detected by the voltage detector. Therefore, the pointer position detector can be halted when the power supply voltage decreases to less than a specific voltage, and the pointer position detector can be driven while the power supply voltage is low.

### BACKGROUND

1. Technical Field

The present invention relates to an analog timepiece, an analog stopwatch, or another electronic apparatus having time display members; a method for detecting the positions of the time display members; and a program for detecting the positions of the time display members.

2. Related Art

In analog radio controlled watches in which pointers are driven, disruptions in the advance of the pointers due to the effects of vibration or external magnetic fields cause the internal pointer position counters and the actual positions of the pointers to deviate from each other, sometimes preventing the received time code from being correctly displayed. In view of this, it is necessary to detect the positions of the pointers in order to confirm whether or not there is a match between the positions of the pointers and the values of the pointer position counters.

One known example of a device for detecting pointer positions in such a radio controlled watch is one that uses an optical sensor having a light-emitting element and a light-receiving element (for example, see Japanese Laid-Open Patent Application No. 5-209970; hereinafter referred to as Prior Art 1).

Devices for detecting pointer positions have gears or other members that move in conjunction with the rotation of the pointers disposed between the light-emitting element and the light-receiving element of the position sensor, and these members are provided with holes for allowing detection light to pass through in specified locations. When detection light emitted from the light-emitting element is passed through these holes and is received by the light-receiving element, the pointers can be detected at specified positions.

With pointer position detectors that use optical sensors, an electric current of several microamperes must be instantaneously sent when the optical sensor is operated, reducing the power supply voltage. The reduction in power supply voltage is particularly significant in electronic apparatuses that have a rechargeable secondary battery as a power supply, because the secondary battery has a high discharge resistance.

Also, to detect the positions of the pointers, pulses for detecting the pointer positions and driving the pointers must be output to the optical sensor and the pointer driving motor a maximum of about 2000 to 5000 times. Specifically, when a pointer position is detected, a one-pulse (one-step) drive signal is input to a pointer-driving stepping motor or the like to drive the pointers by one step, and at this time the optical sensor must determine whether the pointers are in specific positions. Therefore, when the hour and minute hands are driven by one motor, the hour and minute hands can be driven by a maximum amount corresponding to 12 hours in order to be moved to specific positions. If the settings are designed so that a drive signal of 60×6=360 pulses is input to the motor in order to move the minute hand one full rotation (one hour), a drive signal of 360 pulses×12 hours=4320 pulses must be input to drive the minute hand over a distance corresponding to 12 hours, and the same number of drive pulses must be input from the optical sensor in accordance with the input of the drive signal.

At this time, the power supply voltage decreases when the pulse for driving the motor is output, and then the voltage is gradually restored, as shown in FIG. 12. The voltage again decreases when the drive pulse for the pointer position detector is output. The power supply voltage is then gradually restored, but if the next pulse is output before the voltage is completely restored, the voltage decreases on the basis of the restored voltage, and the reduction in the power supply voltage is therefore considerable if the motor is driven and the pointer positions are detected continuously a multiple number of times.

Specifically, if the pointer positions are detected continuously, many electric currents are needed to drive the motor and the optical sensor, and the decrease in the power supply voltage becomes greater.

Greater decreases in power supply voltage have been the cause of instability in the operation of optical sensors and the inability of pointer position detectors to operate normally.

Large decreases in voltage due to pointer position detection have the potential to cause malfunctions in a control unit configured from an IC or CPU, or to cause system failures as a result of data loss in RAM or other storage devices.

Furthermore, providing a backup capacitor has been considered as a possibility for reducing power supply fluctuations, but a capacitor with a high capacity is needed for large decreases in power supply voltage, and problems have been encountered in that installing such a capacitor in small electronic apparatuses such as wristwatches, for example, has been difficult in terms of space efficiency.

Such problems are not limited to radio control watches, and are also common to electronic apparatuses that use an optical sensor or another position detector to detect the positions of a time display member. Such devices include timepieces, stopwatches, timers, and other electronic apparatuses having pointers or other time display members for indicating information.

Furthermore, a radio controlled watch comprising a gear or the like provided with detection holes for detecting the positions of the pointers is also disclosed, similar to the radio controlled watch in Prior Art 1 (for example, see Japanese Patent Application Laid-Open No. 2002-107465, hereinafter referred to as Prior Art 2). The radio controlled watch in Prior Art 2 comprises a center wheel (minute hand wheel) on which the minute hand is mounted, an hour wheel (hour hand wheel) on which the hour hand is mounted, a wheel (second third wheel) meshed with the center wheel, and a wheel (first seconds wheel) that is the first to be driven by the motor for driving the minute hand, and all these wheels are provided with detection holes for allowing light to pass through. In Prior Art 2, light from a light-emitting element is passed through all the detection holes and is received simultaneously by a light-receiving element, whereby the positions of the minute hand and the hour hand in this state are determined as the reference positions (normally the positions exactly at 12:00).

In detecting the position of the minute hand in Prior Art 2, the minute hand is determined to be in the reference position if light passes through the detection opening in the center wheel on which the minute hand is mounted as well as through the detection opening in the wheel initially driven by the motor for driving the minute hand.

However, the angle of rotation by which the motor rotates one step is largely different between the center wheel and the wheel initially driven by the motor. Namely, the single-step angle of rotation is extremely large with the motor wheel, and is extremely small with the center wheel. Therefore, the center wheel rotates only slightly as the motor wheel makes a single turn and reaches a state of light transmission following a state in which both the motor wheel and the center wheel transmit light. As a result, light is transmitted in about the same manner as before, creating a possibility that an accurate reference position will not be obtained.

To obtain an accurate reference position, the detection opening in the center wheel must be made extremely small to ensure that it will be securely outside the range of light transmission when the motor rotates by a small amount in a single step, but the machining method and considerations related to the reduced sensitivity of the light-receiving element due to impeded passage of light impose limits on the extent to which the detection opening can be made smaller, and the detection opening cannot be reduced in size to an adequate degree.

Also, in Prior Art 2, the same problems are encountered with detecting the position of the hour hand. Specifically, the hour hand is determined to be in the reference position if light passes through the detection opening in the hour wheel on which the hour hand is mounted and through the detection opening in the wheel meshed with the hour wheel, but the angle of rotation of the hour hand for each step of the motor is even smaller, and the angle of rotation of the meshing wheel is by no means large. Therefore, the detection holes overlap each other as before even if the motor rotates multiple times, and there is a possibility that light will still be transmitted.

The detection holes of the hour wheel and the wheel enmeshed with the hour wheel may of course be made extremely small, but this solution is limited in the same manner as above and is impractical.

Furthermore, an electronic apparatus comprising such functions for detecting pointer positions tends to be larger than a regular timepiece due to the complexity of its structure, but compactness is preferred because consumers favor compact devices.

### SUMMARY

An object of the present invention is to provide an electronic apparatus in which the decrease in power supply voltage when the positions of the time display members are detected can be suppressed, to provide a method for detecting the positions of the time display members in an electronic apparatus, and to provide a program for detecting the positions of the time display members in an electronic apparatus. Another object of the present invention is to provide an electronic apparatus in which the pointer positions can be reliably detected and whose size can be reduced.

The electronic apparatus of the present invention comprises time display members, a time display member driving device for driving the time display members, a time display member position detector for detecting the positions of the time display members, a control device for controlling the driving of the time display member drive device and the time display member position detector, a power supply for driving the time display member drive device and the control device, and a voltage detection device for detecting the voltage of the power supply; wherein the control device controls the operation of detecting the time display member position by the time display member position detector on the basis of the power supply voltage detected by the voltage detection device.

Also, controlling the operation of detecting the time display member position by means of the control device involves, for example, performing a time display member position detecting operation via the time display member position detector if the power supply voltage detected by the voltage detection device is equal to or greater than a specific voltage, and not performing the operation of detecting the time display member position if the power supply voltage is less than the specific voltage.

According to the present invention, the control device controls the operation of detecting the positions of the time display members on the basis of the power supply voltage, and can therefore halt the operation of detecting the time display member position if the power supply voltage falls below a specific voltage, for example. Accordingly, it is possible to prevent the power supply voltage from reaching an extremely low level by driving the time display member position detector, which may be an optical sensor or the like, while the power supply voltage is low.

Therefore, when an optical sensor is used, for example, as the time display member position detector, the light from the light-emitting element of the optical sensor is fainter, the operation of the light-receiving element becomes unstable, and the operation of detecting the time display member position does not proceed normally, which may result in detection errors. In the present invention, however, the time display member position detector does not operate when the power supply voltage is low. Therefore, the power supply voltage can be prevented from becoming too low, and errors in detecting the time display member positions can be prevented.

Also, when the power supply voltage is low, problems occur with the operation of the control unit or storage device in the electronic apparatus, and system failures may also occur. In the present invention, however, system failures can be reliably prevented because the power supply voltage can be prevented from becoming too low.

Furthermore, there is no need for a high-capacitance backup capacitor to be provided in order to prevent the power supply voltage from becoming too low, a low-capacitance capacitor need only be provided, and the electronic apparatus can therefore be reduced in size and thickness.

In the present invention, it is preferable that the control device detects the power supply voltage via the voltage detection device before the time display member position detection operation, initiates the time display member position operation if the power supply voltage is equal to or greater than a specific voltage, and does not perform the operation of detecting the time display member position if the power supply voltage is less than a specific voltage.

According to the present invention, since the power supply voltage is detected before the operation of detecting the time display member position, it is possible to reliably prevent the operation of detecting the time display member position from being executed when the power supply voltage is low, the occurrence of errors in detecting the time display member positions as well as system failures can be prevented, and the size and thickness of the electronic apparatus can be reduced by eliminating the need for a high-capacitance backup capacitor.

In the present invention, it is preferable that the control device detects the power supply voltage by means of the voltage detection device during the operation of detecting the time display member position, continues the operation of detecting the time display member position if the power supply voltage is equal to or greater than a specific voltage, and stops the operation of detecting the time display member position if the power supply voltage is less than a specific voltage.

According to the present invention, the power supply voltage is detected during the operation of detecting the time display member position. Therefore, if the voltage becomes low as a result of the power supply voltage decreasing due to the operation of detecting the time display member position, the operation of detecting the time display member position can be reliably prevented from continuing in this state, the occurrence of errors in detecting the time display member positions as well as system failures can be prevented, and the size and thickness of the electronic apparatus can be reduced by eliminating the need for a high-capacitance backup capacitor.

In the present invention, it is preferable that the control device detects the power supply voltage by means of the voltage detection device during the operation of detecting the time display member position, continues the operation of detecting the time display member position if the power supply voltage is equal to or greater than a specific voltage, stops the operation of detecting the time display member position if the power supply voltage is less than a specific voltage, and then restarts the operation of detecting the time display member position if the power supply voltage is equal to or greater than a specific voltage.

According to the present invention, since the power supply voltage is detected during the operation of detecting the time display member position, it is possible to reliably prevent the operation of detecting the time display member position from being executed when the power supply voltage has decreased to a low value due to the operation of detecting the time display member position, the occurrence of errors in detecting the time display member positions as well as system failures can be prevented, and the size and thickness of the electronic apparatus can be reduced by eliminating the need for a high-capacitance backup capacitor.

Furthermore, the operation of detecting the time display member position can be automatically restarted when the power supply voltage is charged and restored to a specific voltage or greater once the operation of detecting the time display member position has been stopped. Therefore, the time display members can be more reliably detected, and convenience can be improved.

In these inventions, the desired specific voltage may be the same or different in relation to the power supply voltage. For example, if the power supply voltage is detected solely before the operation of detecting the time display member position is initiated and the power supply voltage is not detected during the operation of detecting the time display member position, then the specific voltage needed to initiate the detection operation is preferably set to be higher than the specific voltage needed to continue the operation of detecting the time display member position during this operation.

If the power supply voltage is detected both before the operation of detecting the time display member position is initiated and during the operation of detecting the time display member position, then the specific voltage needed to initiate the detection operation and the specific voltage needed to continue the operation of detecting the time display member position during this operation may be set to either the same or different values. If the voltage values are different, then the specific voltage for initiating the detection operation may be set relatively high so that the operation can continue to some degree when the voltage decreases as a result of initiating the detection operation, for example, and the specific voltage for continuing the detection operation during this operation may be set to a limited low voltage.

Also, when the power supply voltage is detected during the operation of detecting the time display member position, the specific voltage needed to stop the detection operation and the specific voltage needed to halt the detection operation on the assumption that it will be restarted may be the same or different voltage values. If the voltage values are different, it is preferable, for example, that when the detecting operation is stopped, the specific voltage is set to a low value so that the detecting operation can be continued as long as possible, and when the detecting operation is restarted, the specific voltage is set to a high voltage value in comparison with a case in which the detecting operation is stopped so that the power supply voltage can be quickly increased to restart the detecting operation.

Furthermore, when the power supply voltage is detected during the operation of detecting the time display member position, the specific voltage needed to halt the detecting operation and the specific voltage needed to restart the detecting operation may be the same or different voltage values. If the voltage values are different, for example, it is preferable to set the specific voltage needed to restart the detecting operation to be higher than the specific voltage needed to halt the detecting operation, because the detecting operation can be continuously performed to a certain degree without halting and restarting being repeated in short intervals.

In other words, the specific voltages can be set independently of each other, and may be set in an appropriate manner in accordance with the application.

In the present invention, it is preferable that when the power supply voltage is equal to or greater than a specific voltage and the operation of detecting the time display member position is performed, the control device reduces the range of time display member position detection in comparison with a case in which the power supply voltage is equal to or greater than a second specific voltage if the power supply voltage is less than the second specific voltage.

The term “range of time display member position detection” as used herein refers to the range in which the time display members are moved when it is determined whether or not the time display members are in specific positions. For example, if the time display members rotate 360 degrees, such as with the pointers or date wheel of a timepiece, then the maximum value of the range of time display member position detection is the range in which the time display members make one full rotation, namely, a range of 360 degrees. Therefore, the angle of rotation of the time display members may be controlled to 60 degrees, for example, in order to reduce the range of time display member position detection to be less than a full rotation.

Also, the second specific voltage may be a voltage greater than the first specific voltage, that is, it may be set in an appropriate manner in accordance with the application. In other words, if the range of time display member position detection is not reduced, then the second specific voltage may be set to a level at which there is a danger of the power supply voltage decreasing to a point where a system failure occurs when the operation for detecting the positions of the time display members is executed. Specifically, the second specific voltage may be the lower limit of a voltage value at which the power supply voltage does not decrease to a point where a system failure occurs, even if the position detecting operation is executed in a range of time display member position detection that is not narrowly controlled.

In the present invention, if, for example, the specific voltage is set to 1.25 V and the second specific voltage is set to 1.30 V, the control device does not perform the operation of detecting the time display member position as long as the power supply voltage is less than 1.25 V. On the other hand, if the power supply voltage is equal to or greater than the second specific voltage of 1.30 V, then the control device performs the operation of detecting the time display member position within a range in which the time display members make a full rotation, for example. Also, if the power supply voltage is less than the second specific voltage of 1.30 V and is equal to or greater than the specific voltage of 1.25 V, then the control device performs the operation of detecting the time display member position within a range in which the time display members are rotated by 30 degrees, for example.

Therefore, in the present invention, if the power supply voltage is equal to or greater than the second specific voltage, then the range of time display member position detection can be increased to improve the probability that the time display members can be detected, and the power supply voltage does not decrease to a point where a system failure occurs, even if the range of time display member position detection is increased.

Also, when the power supply voltage is less than the second specific voltage and is equal to or greater than the first specific voltage, the range of time display member position detection is reduced, and therefore the reduction in the power supply voltage can be reduced accordingly. As a result, the power supply voltage can be prevented from decreasing to a point where a system failure occurs due to the operation of detecting the time display member position, even if the power supply voltage is somewhat low.

In the present invention, it is preferable that when the power supply voltage is equal to or greater than a specific voltage and the operation of detecting the time display member position is performed, the control means increases the cycle of operation for detecting the time display member position in comparison with a case in which the power supply voltage is equal to or greater than the second specific voltage if the power supply voltage is less than the second specific voltage.

The term “cycle of the operation of detecting the time display member position” as used herein refers to the processing cycle (time interval) when a single cycle of the routine for detecting the time display member position is composed of a specific amount of time display member movement (for example, a movement corresponding to a single step of the motor) and the operation of detecting the time display member position performed by driving the time display member position detector after the time display members have been moved. Therefore, the term “the long cycle of the operation of detecting the time display member position” refers to a case in which the number of processing cycles between individual units of time (one minute, for example) is reduced and the time of one processing cycle is increased. For example, when the power supply voltage is equal to or greater than the second specific voltage, the cycle of operation for detecting the time display member position may be set at 1/32 of a second while driving the pointers at 32 Hz, for example, and when the power supply voltage is less than the second specific voltage and is equal to or greater than the specific voltage, the cycle of operation for detecting the time display member position may be set longer at 1/16 of a second while the pointers are driven at 16 Hz, for example.

Also, the second specific voltage may be a voltage greater than the first specific voltage; specifically, may be a voltage that is set in an appropriate manner in accordance with the application. In other words, the second specific voltage may be set to a level at which the power supply voltage might decrease to a point where a system failure occurs if the detection cycle is not lengthened. Specifically, the second specific voltage may be the lower limit of a voltage value at which the power supply voltage does not decrease to a point where a system failure occurs due to the position detecting operation, even if the detection cycle is lengthened.

In the present invention, when the power supply voltage is less than the second specific voltage and equal to or greater than the first specific voltage, the cycle of operation for detecting the time display member position is lengthened, and the drop in the power supply voltage can therefore be reduced accordingly. Specifically, the voltage decreases due to the driving of the motor and the operation of detecting the time display member position, and then is gradually restored to the original voltage. If the cycle of operation for detecting the time display member position is short, the drop in the power supply voltage becomes even greater and the power supply voltage decreases as a result of the subsequent motor driving or the operation of detecting the time display member position while the power supply voltage is not yet restored. If the cycle of operation for detecting the time display member position is lengthened to compensate for this decrease, the power supply voltage can be restored before the motor is driven or the operation of detecting the time display member position is performed again, and the decrease in power supply voltage can be reduced accordingly.

In the present invention, it is preferable that when the power supply voltage is equal to or greater than a specific voltage and the operation of detecting the time display member position is performed, the control means reduces the number of pointer positions to be detected in comparison with a case in which the power supply voltage is equal to or greater than the second specific voltage if the power supply voltage is less than the second specific voltage.

The term “pointer positions to be detected” as used herein refers to time display members that are set so that time display member positions can be individually detected.

For example, when the configuration is designed so that the positions of the seconds hand and the hour and minutes hands can be detected individually, both the seconds hand and the hour and minute hands may be objects of detection if the power supply voltage is equal to or greater than the second specific voltage, and only one of the seconds hand or hour and minute hands may be the object of detection if the power supply voltage is less than the second specific voltage and is equal to or greater than the first specific voltage.

Furthermore, when the configuration is designed so that the positions of the seconds hand, the hour and minute hands, and the date wheel can be detected individually, then the seconds hand, the hour and minute hands, and the date wheel may all be objects of detection if the power supply voltage is equal to or greater than the second specific voltage, and only the seconds hand and the hour and minute hands may be objects of detection if the power supply voltage is less than the second specific voltage and is equal to or greater than the first specific voltage.

Also, the second specific voltage may be a greater voltage than the first specific voltage, and may specifically be a suitable voltage according to the application. In other words, if the objects of detection are not limited (reduced), the second specific voltage may be set to a level at which the power supply voltage may decrease to a point where a system failure occurs. Specifically, the second specific voltage may be the lower limit of a voltage value at which the power supply voltage does not decrease to a point where a system failure occurs due to the position detecting operation, even if the objects of detection are not limited.

In the present invention, the number of time display member positions to be detected is reduced when the power supply voltage is less than the second specific voltage and equal to or greater than the first specific voltage, and the drop in the power supply voltage can therefore be reduced accordingly.

In these inventions, the second specific voltage can be set independently, may the same or different, and may be set in an appropriate manner in accordance with the application.

The present invention preferably comprises a voltage-enhancing device for increasing the voltage supplied from the power supply, wherein the control device controls the voltage-enhancing device on the basis of the voltage value of the power supply voltage, and the power supply voltage is varied.

For example, the control device does not perform the operation of detecting the time display member position when the voltage value of the power supply voltage is less than the first specific voltage, the control device performs the operation of detecting the time display member position while increasing the power supply voltage via the voltage-enhancing device when the voltage value is equal to or greater than the first specific voltage and is less than a third specific voltage, and the control device performs the operation of detecting the time display member position without increasing the power supply voltage when the voltage value is equal to or greater than the third specific voltage.

In the present invention, the voltage can be increased by the voltage-enhancing device when the power supply voltage is somewhat low, making it possible to drive the time display member position detector and the drive device of the time display members in a reliable manner.

The third specific voltage may be a greater voltage than the first specific voltage, and may specifically be set in an appropriate manner in accordance with the application. The third specific voltage may either be the same or different voltage value as the second specific voltage.

The present invention preferably comprises time display member position counters for displaying the positions of the time display members, wherein the control device corrects the time display member position counters to specific values and synchronizes the time display members and the time display member position counters when the time display members are detected in the operation of detecting the time display member position.

In the present invention, since the time display members and the time display member position counters can be reliably synchronized by the operation of detecting the time display member position, the pointer values can be reliably indicated when the time display members are moved based on the data of the time display member position counters, and specific information is indicated (displayed).

In the present invention, it is preferable that the time display member position detector comprises a light-emitting element for emitting light and a light-receiving element for receiving light, the time display member drive device comprises a motor and a gear train driven by the motor, and the gear train is configured including a first wheel enmeshed with the rotor pinion of the motor, a second wheel on which a time display member is mounted, and a third wheel disposed between the first and second wheel, wherein the first through third wheels are provided with detection holes at mutually overlapping positions for transmitting light between the elements.

Essentially, in the present invention, the positions of the time display members are detected by light transmission on the basis of the first wheel enmeshed with the rotor pinion and the third wheel that extends to the second wheel, and the second wheel on which a time display member is mounted may be provided with a detection opening so as not to hinder light transmission. Since the first and third wheels are on the side near the motor, their angles of rotation in a single motor step are both greater, it becomes difficult for the detection holes to continue to overlap when the motor goes through steps in a continual manner, and precision of detection is improved.

Moreover, the first through third wheels are arranged in a concentrated manner so that an area is created in which the wheels overlap in the same plane, resulting in improved space efficiency and allowing for size reduction by preventing the layout of the gear train from expanding in the radial direction.

In the present invention, it is preferable that the time display member drive device comprises another gear train that is disposed coaxially with the second wheel and that includes a fourth wheel on which a different time display member from the previous time display member is mounted, and another motor for driving this gear train; and the time display member position detector comprises another light-emitting element and light-receiving element that are different from the previous light-emitting element and light-receiving element, wherein the position of the time display member mounted on the fourth wheel is detected at a position that does not overlap the second wheel in the same plane by using the other light-emitting element and light-receiving element.

According to the present invention, since the time display member mounted on the fourth wheel and the time display member mounted on the second wheel are driven by separate gear trains, the time display members can be driven individually and be aligned with the reference position or the like, and the positions can be aligned in a short amount of time. Also, the detection circuits can be simplified and reliability can be improved because the light-emitting elements and light-receiving elements used to detect the positions of the time display members are provided separately.

In the present invention, it is preferable that the number of teeth in the rotor pinion enmeshed with the first wheel is eight or more.

A rotor is commonly configured from two or more components, including a rotor magnet and a rotor pinion. To reliably detect the positions of the time display members, the phases in the direction of rotation must be aligned between the N or S pole of the rotor magnet and the tooth profile of the rotor pinion. If the phases in the direction of rotation and the tooth profile of the rotor pinion do not match, the phase in the direction of rotation of the rotor pinion is determined depending on the static stable position of the rotor determined by the shape of the stator (the position of the phase in the direction of rotation at which the rotor is stable when a motor pulse is not applied to the coil), and therefore the phase shift of the rotor pinion is at most half of the pitch of the tooth profile of the rotor pinion. The detection opening in the first wheel enmeshed with the rotor pinion stops at a position having a considerable phase shift, and the positions of the time display members cannot be correctly detected. A regular rotor pinion is not provided with a very large outside diameter so as to reduce the inertia moment and to simplify control, and at the most has seven teeth.

However, in order to match the phases of the rotor magnet and the tooth profile of the rotor pinion, the poles of the rotor magnet must be controlled, and no rotation misalignment is allowed when they are fixed in place. Therefore, manufacturing and assembling the components becomes extremely time consuming, and the yield rate decreases.

In view of this, in the present invention, the rotor pinion has eight or more, and preferably ten or more teeth, and even if the phases of the rotor magnet and the rotor pinion have maximum misalignment, the detection opening in the first wheel enmeshed with the rotor pinion is essentially not affected. As a result, components can be easily manufactured and assembled without needless attention to the phases.

The electronic apparatus of the present invention is preferably an electronic timepiece comprising an internal timekeeping device for keeping the time, and a time display device for displaying the time kept by the internal timekeeping device using the time display members.

Normally, the time display members for displaying the time can be pointers including an hour hand, minute hand, and seconds hand for displaying the hours, minutes, and seconds. A date wheel or the like for displaying the date, the day of the week, and other calendar information can also be considered a time display member in the present invention.

If the electronic apparatus of the present invention is applied to an electronic timepiece, the positions of the pointers or other time display members can be confirmed with a time display member position detector, and therefore it is possible to confirm whether the internal time (internal counter value) kept by the internal timekeeping device matches the time indicated by the pointers or other time display members, and if there is no match, the amount by which the time display members are misaligned with respect to the internal time can be determined by confirming the internal time when the time display members are detected. Therefore, the amount of time display member misalignment can be detected and corrected so that the internal time and the time indicated by the time display members coincide, and even if the time display members move relative to their support axis, resulting in a misalignment in the time displayed by the time display members because of collisions that cause a time lag or error in the stepping motor due to an external magnetic field or the like, the misalignment can still be corrected to display the correct time. Particularly, a highly precise time display can be expected if the electronic timepiece is a radio controlled watch. In the present invention, an even more precise time display can be achieved and customer satisfaction can be improved because display errors due to pointer misalignments can be prevented.

Moreover, in the present invention, it is possible to prevent the power supply voltage from reaching an extremely low level by driving the time display member position detector having an optical sensor while the power supply voltage is low, errors in detecting the time display member positions as well as system failures of the control unit can be prevented, misalignments in the positions of the pointers or other time display members can be prevented, and a timepiece having high pointer precision can be provided.

Furthermore, since a low-capacitance capacitor can be used, the size and thickness of the electronic timepiece can be reduced, and the present invention can be applied to a small electronic timepiece, such as a wristwatch.

The electronic apparatus of the present invention is preferably an electronic timepiece comprising an internal timekeeping device for keeping the time, and a time display device for displaying the time kept by the internal timekeeping device using the time display members, wherein the time display member mounted on the second wheel is a minute hand, the time display member drive device comprises an hour wheel on which the hour hand is mounted and which is driven via a date rear wheel enmeshed with the second wheel coaxially with the second wheel, and the hour wheel is also provided with a detection opening that overlaps the detection holes of the first through third detection holes.

According to the present invention, in a timepiece with a 12-hour display, since the hour wheel rotates in a 12-hour cycle, the timing at which light is transmitted through the detection holes in the first through third wheels and the hour wheel can also be configured according to a 12-hour cycle, one location such as the 12:00 position can be set as the reference position for the minute hand and hour hand, and control based on the reference position is easily achieved.

In the present invention, it is preferable that the minute hand is moved in a cycle of five seconds or less.

With motor-driven quartz timepieces, it is often the case that, compared with mechanical timepieces, only a thinly looking minute hand is mounted because of a low motor output torque and other reasons. Timepieces used for sports in particular include many timepieces with a robust image whose externally mounted components have a bulky design, for which large minute hands that match this appearance are desired.

However, when a large minute hand is mounted, the second wheel must be driven with a strong torque, which is uneconomical because the lifetime of the battery is greatly reduced.

In view of this, normally in a quartz timepiece with a structure in which the seconds hand is driven by a separate motor or gear train, the minute hand is moved in a cycle of ten seconds (or a cycle of 20 or 30 seconds or the like), but in the present embodiment, the cycle is five seconds or less, and the number of teeth in the gear train is increased proportionately to increase the gear reduction ratio. As a result, twice the torque can be retained by the second wheel in comparison with a case in which a gear train with a ten-second cycle movement is used (for example, a five-second cycle movement), the pointers can be reliably moved with less energy consumption even if a larger minute hand is used, and a favorable appearance can be achieved.

In the present invention, it is preferable that a calendar display device is configured including another gear train in addition to the gear train that has the second wheel and/or the fourth wheel, and another motor for driving the other gear train.

If the hours and minutes and the calendar display device with a calendar function are both driven with one gear train and one motor, there is no need for a wheel provided with a detection opening other than the hour wheel (in the embodiment described below, the date-turning wheel 333, for example), because it is impossible to distinguish between AM and PM and to determine the date when detecting the pointer positions in a 12-hour cycle. This results in a structure in which the pointer positions in the gear train for the hour and minute hands are detected by overlapping the detection holes of six or more wheels, and an extremely complicated gear train configuration is thus produced. In this structure, the time required for detection is two or more times that of the prior art, size (and thickness) is increased because of the greater number of gear trains required to detect the pointer positions, and assembly of the gear train is more complicated.

In the present invention, however, the calendar display device is driven by a gear train and motor that are separate from the hour and minute hands and the seconds hand. Therefore, the time to detect the pointer positions can be shortened, the size of the timepiece can be reduced, and the gear train for the pointers can be simplified.

In the above descriptions, the first through fourth wheels are preferable formed from a metal or another material with good light-blocking effects. The material may be a synthetic resin if cost is a concern, in which case a blackish material should be used for its light-blocking effects.

The method for detecting the positions of time display members in an electronic apparatus according to the present invention is a method for detecting the positions of time display members in an electronic apparatus comprising time display members, a time display member drive device for driving the time display members, a time display member position detector for detecting the positions of the time display members, and a power supply; wherein the method comprises a voltage detection step for detecting the voltage of the power supply, and a time display member position detection control step wherein the operation of detecting the time display member position by the time display member position detector is controlled on the basis of the power supply voltage detected in the voltage detection step.

The program for detecting the positions of time display members in an electronic apparatus according to the present invention is a program for detecting the positions of time display members in an electronic apparatus comprising time display members, a time display member drive device for driving the time display members, a time display member position detector for detecting the positions of the time display members, and a power supply; wherein the program executes a voltage detection step for detecting the voltage of the power supply, and a time display member position detection control step wherein the operation of detecting the time display member position by the time display member position detector is controlled on the basis of the power supply voltage detected in the voltage detection step, the steps being executed on a computer incorporated into the electronic apparatus.

The recording medium of the present invention is a recording medium that can be read by a computer on which the program for detecting the positions of time display members is recorded.

In these inventions, the same operational effects as those of the previously described electronic apparatus can be achieved, in that the decrease in power supply voltage can be suppressed, errors in detecting the time display member positions and system failures can be prevented, the capacitance of the back-up capacitor can be reduced, and the size and thickness of the electronic apparatus can be reduced.

The method for detecting the positions of time display members in the electronic apparatus of the present invention may also include a voltage detection step for detecting the power supply voltage by means of a voltage detection device before the operation of detecting the time display member position, and a time display member position detection control step whereby the operation of detecting the time display member position is initiated when the power supply voltage is equal to or greater than a specific voltage, and the operation of detecting the time display member position is not performed when the power supply voltage is less than the specific voltage.

Also, the method for detecting the positions of time display members in the electronic apparatus of the present invention may include a voltage detection step for detecting the power supply voltage by means of a voltage detection device during the operation of detecting the time display member position, and a time display member position detection control step whereby the operation of detecting the time display member position is continued when the power supply voltage is equal to or greater than a specific voltage, and the operation of detecting the time display member position is stopped when the power supply voltage is less than the specific voltage.

Also, the method for detecting the positions of time display members in the electronic apparatus of the present invention may include a voltage detection step for detecting the power supply voltage by means of a voltage detection device during the operation of detecting the time display member position, and a time display member position detection control step whereby the operation of detecting the time display member position is continued when the power supply voltage is equal to or greater than a specific voltage, the operation of detecting the time display member position is halted when the power supply voltage is less than the specific voltage, and then the operation of detecting the time display member position is resumed when the power supply voltage is restored to the specific voltage or greater.

Also, the method for detecting the positions of time display members in the electronic apparatus of the present invention may include a time display member position detection control step in which the range of time display member position detection is reduced in comparison with a case in which the power supply voltage is equal to or greater than the second specific voltage, if the power supply voltage is equal to or greater than the specific voltage and the operation of detecting the time display member position is performed, and if the power supply voltage is less than a second specific voltage.

Also, the method for detecting the positions of time display members in the electronic apparatus of the present invention may include a time display member position detection control step in which the cycle of operation for detecting the time display member position increased in comparison with a case in which the power supply voltage is equal to or greater than the second specific voltage whereby, if the power supply voltage is equal to or greater than the specific voltage and the operation of detecting the time display member position is performed, and if the power supply voltage is less than a second specific voltage.

Also, the method for detecting the positions of time display members in the electronic apparatus of the present invention may include a time display member position detection control step in which the number of time display member positions to be detected is reduced in comparison with a case in which the power supply voltage is equal to or greater than the second specific voltage, if the power supply voltage is equal to or greater than the specific voltage and the operation of detecting the time display member position is performed, and if the power supply voltage is less than a second specific voltage.

Also, the method for detecting the positions of time display members in the electronic apparatus of the present invention may include a voltage-enhancing device for increasing the voltage supplied form the power supply, and a power supply voltage varying step for controlling the voltage-enhancing device and varying the power supply voltage on the basis of the value of the power supply voltage.

Also, the method for detecting the positions of time display members in the electronic apparatus of the present invention may include a time display member synchronizing step in which time display member position counters are provided for displaying the positions of the time display members, and the time display member position counters are corrected to specific values and the time display members are synchronized with the time display member position counters when the time display members are detected in the operation of detecting the time display member position.

In these methods for detecting the positions of time display members, the same effects can be achieved as in the inventions constituting the electronic apparatus.

### BRIEF DESCRIPTION OF THE DRAWINGS

FIG. 1 is a plan view showing a timepiece according to the first embodiment of the present invention;

FIG. 2 is a plan view showing the same timepiece;

FIG. 3 is a cross-sectional side view showing the same timepiece;

FIG. 4 is an enlarged plan view showing the main section of the same timepiece;

FIG. 5 is a cross-sectional side view showing the main section of the same timepiece;

FIG. 6 is a block view showing the configuration of the control device of the same timepiece;

FIG. 7 is a circuit diagram showing the pointer position detector of the same timepiece;

FIG. 8 is a flowchart showing the process of detecting the pointer positions in the same timepiece;

FIG. 9 is a flowchart showing the process of detecting the pointer positions when the timepiece is started up or the system is reset;

FIG. 10 is a flowchart showing the process of detecting the pointer positions when the timepiece is at 0:00 or 12:00;

FIG. 11 is a flowchart showing the process of detecting the pointer positions with each step in the timepiece; and

FIG. 12 is a graph showing the fluctuation in power supply voltage as a result of driving the motor and detecting the pointer positions.

### DESCRIPTION OF EXEMPLARY EMBODIMENTS

The first embodiment of the present invention will now be described with reference to the diagrams.

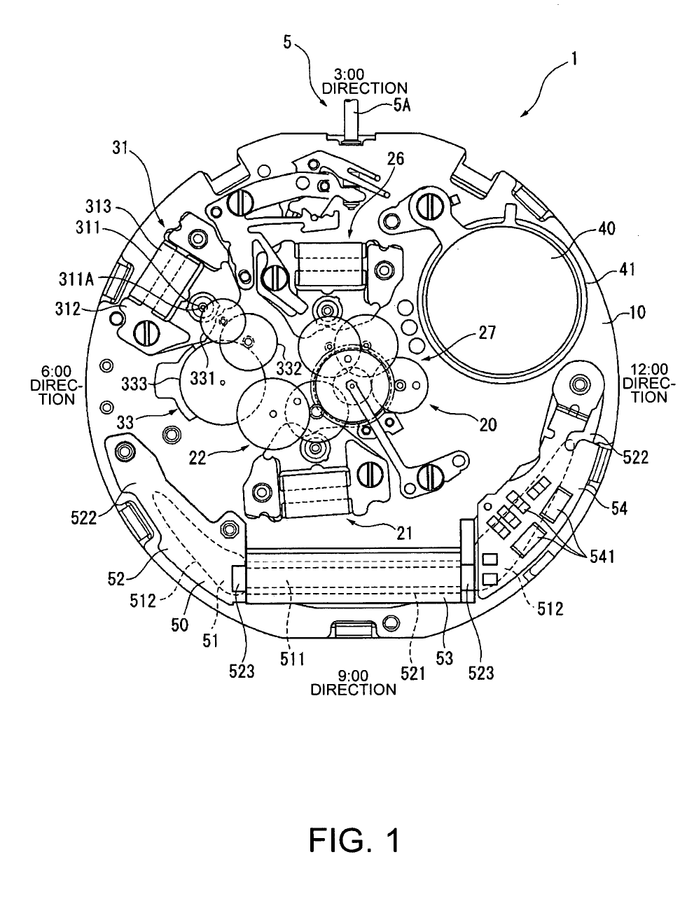

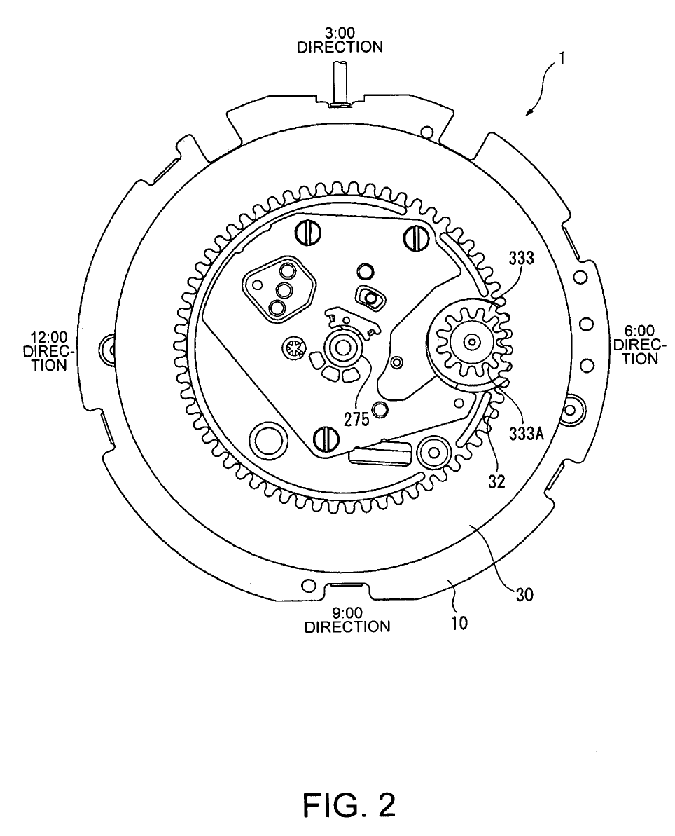

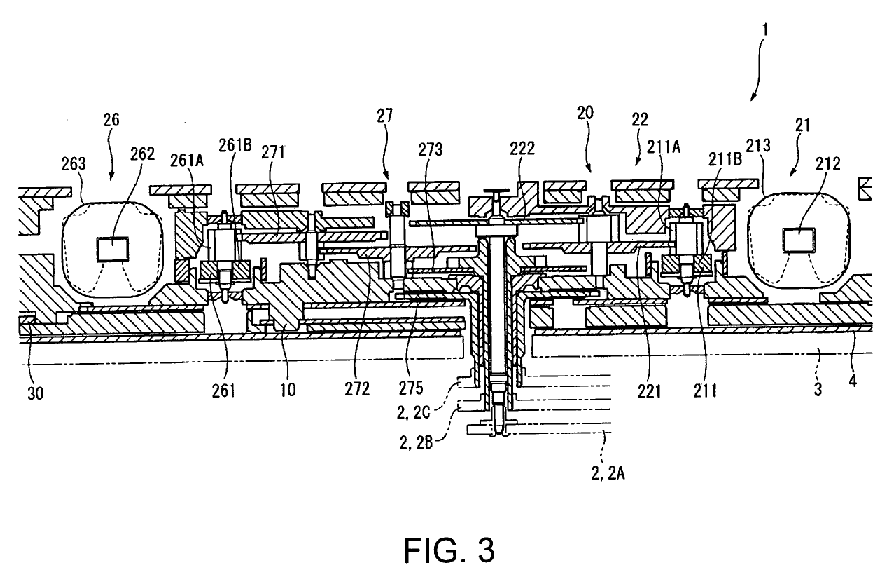

FIGS. 1 and 2 show plan views of a timepiece 1 as an electronic apparatus and an electronic timepiece according to the first embodiment of the present invention. FIG. 3 shows a cross-sectional side view of the timepiece 1. In these FIGS. 1, 2, and 3, the timepiece 1 is a radio controlled watch that has a pointer position detecting function, receives reference radio waves as external signals carrying time information, and corrects the displayed time. The timepiece has a 12-hour display. The timepiece 1 includes pointers 2 for displaying the time (FIG. 3), a pointer drive device 20 for driving the pointers 2, a date wheel 30 (FIG. 2) as a calendar display mechanism for displaying the date (calendar), a calendar drive device 31 for driving the date wheel 30, a power supply storage unit 41 for storing a battery 40, an antenna 50 for receiving the reference radio waves, an external operating device 5 that can be operated externally by the user, and a main plate 10 as a casing for supporting and accommodating the pointer drive device 20, the date wheel 30, the calendar drive device 31, the power supply storage unit 41, and the antenna 50. The main plate 10 is formed into a substantially circular flat-plate shape, and the structural components of the timepiece 1 are disposed on the main plate 10.

FIG. 1 is a diagram as seen from the side (back lid side) opposite to the one on which the time is displayed on the timepiece 1. In this diagram, the top is the 3:00 direction of the timepiece 1, the bottom is the 9:00 direction, the right side is the 12:00 direction, and the left side is the 6:00 direction. FIG. 2 is a diagram of the timepiece 1 as seen from the time display side. In this diagram, the top is the 3:00 direction of the timepiece 1, the bottom is the 9:00 direction, the right side is the 6:00 direction, and the left side is the 12:00 direction.

The pointers 2 include a seconds hand 2A, a minute hand 2B, and an hour hand 2C. The hands are disposed on the same axis and can rotate around approximate center of the main plate 10. The seconds hand 2A, minute hand 2B, and hour hand 2C are provided on the time display side, and these hands display the time by pointing to numbers and the like on a dial 3.

The pointer drive device 20 includes a seconds hand motor 21 for driving the seconds hand 2A, and an hour/minute hand motor 26 for driving the hour hand 2C and the minute hand 2B. Also, a seconds hand reduction gear train 22 for transmitting drive force from the seconds hand motor 21 to the seconds hand 2A is provided between the seconds hand 2A and the seconds hand motor 21, and an hour/minute reduction gear train 27 for transmitting drive force from the hour/minute hand motor 26 to the hour hand 2C and minute hand 2B is provided between the hour hand 2C and minute hand 2B and the hour/minute hand motor 26.

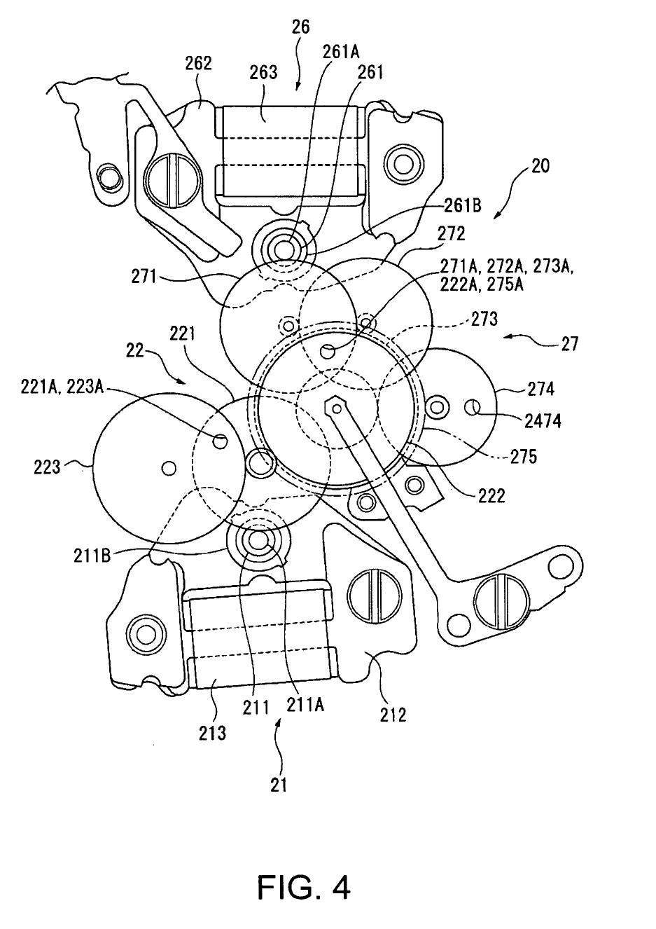

FIG. 4 depicts an enlarged diagram with the pointer drive device 20 removed. As shown in FIG. 4 and in FIG. 1 above, the seconds hand motor 21 has a stepping motor and includes a rotor 211 having a rotor magnet 211B, a stator 212 for rotatably supporting the rotor 211, and a coil 213 connected to the stator 212. The seconds hand motor 21 is placed substantially in the 9:00 direction of the timepiece 1, and is disposed at a position so that the rotor 211 is in the middle of the main plate 10, and the coil 213 is on the outer periphery of the main plate 10.

The seconds hand reduction gear train 22 includes a seconds intermediate wheel 221 enmeshed with a rotor pinion 211A formed integrally on the rotor 211, and a seconds wheel 222 as a fourth wheel enmeshed with the seconds intermediate wheel 221. The seconds hand 2A is fixed in place on the seconds wheel 222. When a motor pulse is supplied to the coil 213, a magnetic path is formed in the stator 212 by electromagnetic induction, and the rotor 211 makes half a rotation with one pulse. This rotational movement is transmitted sequentially to the rotor pinion 211A, the seconds intermediate wheel 221, and the seconds wheel 222 while being decelerated at a suitable rate of deceleration (rate of acceleration), and the seconds hand 2A is rotated at a specific speed per second per pulse.

A seconds detection wheel 223 for detecting the seconds hand 2A in the 12:00 position is meshed with the seconds intermediate wheel 221. Detection holes 221A and 223A are formed in mutually overlapping areas in the seconds intermediate wheel 221 and the seconds detection wheel 223, and the phases of the seconds intermediate wheel 221 and seconds detection wheel 223 are set so that the positions of the detection holes 221A and 223A coincide when the seconds hand 2A is disposed at the 12:00 position. In other words, the 12:00 position is the reference position of the seconds hand 2A. Since the seconds detection wheel 223 is formed with the same diameter as the seconds wheel 222, the result is that the positions of the detection holes 221A and 223A coincide once each minute.

A photosensor (not shown) is provided to a position at which the detection holes 221A and 223A coincide. The photosensor includes a light-emitting element and a light-receiving element. These light emitting and light-receiving elements are provided at opposite ends of the seconds intermediate wheel 221 and the seconds detection wheel 223 in the thickness direction, and are disposed facing each other so as to sandwich these wheels in between. When the seconds intermediate wheel 221 and the seconds detection wheel 223 rotate and the detection holes 221A and 223A coincide, light from the light-emitting element of the photosensor is transmitted via the detection holes 221A and 223A and received by the light-receiving element, and the seconds hand 2A is detected as being in the 12:00 (0 seconds) position. In the present embodiment, while metal is used for the material of the seconds wheel 222 and the seconds detection wheel 223, a synthetic resin, which is superior in terms of cost efficiency, is used for the material of the seconds intermediate wheel 221. A blackish resin can be satisfactorily used as the synthetic resin because of its effects of blocking the detection light in the areas outside the detection opening 221A.

The seconds-hand position detector for detecting the position of the seconds hand 2A is not limited to one that uses a transmissive photosensor, and may be one that uses a reflective photosensor, for example. Neither is this device limited to one that detects when the detection holes 221A and 223A coincide, and may instead detect the position of the seconds hand 2A as a result of a magnetic pattern being formed over the periphery of the seconds detection wheel 223 or the seconds intermediate wheel 221, and this magnetic pattern being read by a hall element or the like, for example.

The hour/minute hand motor 26 is configured from a stepping motor, similar to the seconds hand motor 21, and includes a rotor 261 having a rotor magnet 261B, a stator 262 for rotatably supporting the rotor 261, and a coil 263 connected to the stator 262. The hour/minute hand motor 26 is placed substantially in the 3:00 direction of the timepiece 1, and is disposed at a position so that the rotor 261 is in the middle of the main plate 10, and the coil 263 is on the outer periphery of the main plate 10.

The hour/minute reduction gear train 27 includes a fifth wheel 271 as the first wheel enmeshed with a rotor pinion 261A formed integrally on the rotor 261, a third wheel 272 as the third wheel enmeshed with the fifth wheel 271, a second wheel 273 as the second wheel enmeshed with the third wheel 272, a minute wheel 274 enmeshed with the second wheel 273, and an hour wheel 275 enmeshed with the minute wheel 274. The second wheel 273 and the hour wheel 275 are disposed coaxially with the seconds wheel 222, the minute hand 2B is fixed in place on the second wheel 273, and the hour hand 2C is fixed in place on the hour wheel 275. When a motor pulse is supplied to the coil 263 in cycles of five seconds, a magnetic path is formed in the stator 262 by electromagnetic induction, and the rotor 261 makes half a rotation with one pulse. This rotational movement is transmitted sequentially to the rotor pinion 261A, the fifth wheel 271, the third wheel 272, and the second wheel 273 while being decelerated at a suitable rate of deceleration (rate of acceleration), and the second wheel 273 and minute hand 2B rotate at a speed of one cycle per hour. Also, the rotational movement of the second wheel 273 is transmitted sequentially to the minute wheel 274 and the hour wheel 275 while being decelerated at a suitable rate of deceleration (rate of acceleration), and the hour wheel 275 and hour hand 2C rotate at a speed of one cycle every 12 hours.

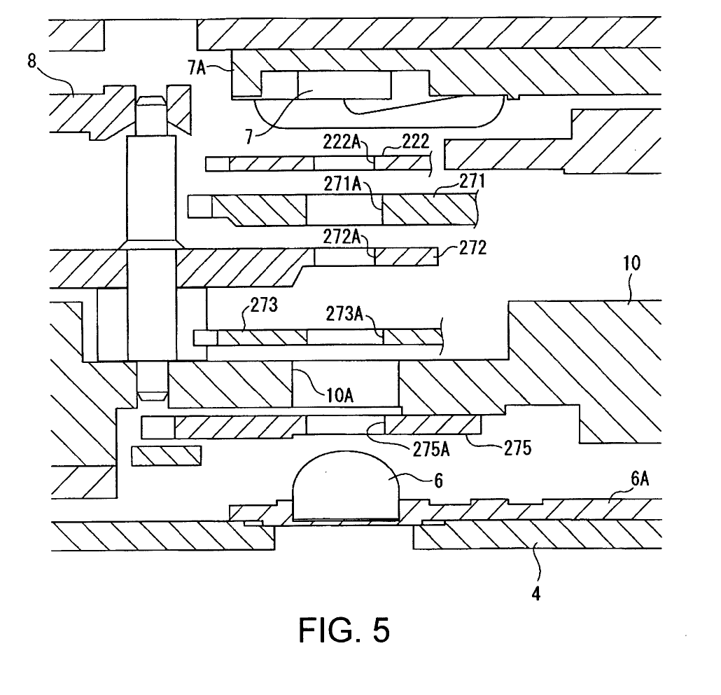

In the present embodiment, there are ten teeth in the rotor pinion 261A, which is more than seven in a regular quartz timepiece. The rotor 261 is configured from two components, the rotor magnet 261B and the rotor pinion 261A. As will be hereinafter described, normally the phases in the direction of rotation of the N pole or S pole of the rotor magnet 261B and the tooth profile in the rotor pinion 261A must be matched in order to reliably detect the positions of the pointers 2. In the present embodiment, however, the rotor pinion 261A has ten teeth, and even if the phases of the rotor magnet 261B and the rotor pinion 261A have maximum misalignment, there is no substantial effect on the detection opening 271A (FIG. 5) in the fifth wheel 271 enmeshed with the rotor pinion 261A. The same applies to the 211A, which constitutes the seconds hand motor 21.

Detection holes 271A, 272A, 273A, 222A, and 275A are formed in mutually overlapping areas in the fifth wheel 271, the third wheel 272, the second wheel 273, the seconds wheel 222, and the hour wheel 275, respectively, as shown in FIG. 5. The hour hand 2C, the minute hand 2B, and the seconds hand 2A are set so that when they are disposed in the 12:00 position, the positions of the detection holes 271A, 272A, 273A, and 222A coincide. In other words, in addition to the seconds hand 2A, the reference positions of the hour hand 2C and minute hand 2B are also in the 12:00 position.

A transmissive photosensor similar to the one provided to the seconds hand motor 21 is also provided to the position where the detection holes 271A, 272A, 273A, 222A, and 275A coincide, and when the positions of the detection holes 271A, 272A, 273A, 222A, and 275A coincide, the light emitted from the light-emitting element 6 is received and detected by the light-receiving element 7, whereby the hour hand 2C, the minute hand 2B, and the seconds hand 2A are all detected as being in the 12:00 position, which is the reference position. Therefore, in the present embodiment, the light-emitting element 6 is mounted on a circuit block 6A disposed between the main plate 10 and a solar panel 4 (generation part, generation means), and the light-receiving element 7 is mounted on a circuit block 7A that covers the gear train bearing 8, with the five wheels 271, 272, 273, 222, and 275 disposed between these elements 6 and 7. In this case, a light transmitting opening 10A should naturally be provided to the main plate 10 so as not to hinder light transmission. Furthermore, in the hour/minute reduction gear train 27, the fifth wheel 271 and the third wheel 272 are also made of a synthetic resin similar to the seconds intermediate wheel 221 previously described.

In the timepiece 1 having a 12-hour display according to the present embodiment, since the reference position of the pointers 2 encompasses a 12-hour cycle, the reference position of the pointers 2 including the hour hand 2C can be specified as one location within a 360-degree display range, namely, the 12:00 position, by providing a detection opening 275A to the hour wheel 275 that similarly rotates in a 12-hour cycle. An arbitrary detection system can be used as the pointer position detector for detecting when the pointers 2 are in the reference position, similar to the second hand position detector. Also, the positions of the elements 6 and 7 may be in a reverse relationship.

Of the detection holes 271A, 272A, 273A, 222A, and 275A, the most important holes for actually detecting the pointer positions are the detection opening 271A in the fifth wheel 271 enmeshed with the rotor pinion 261A, and the detection opening 272A in the third wheel 272 enmeshed with the fifth wheel. The rotating speed of these wheels 271 and 272 is higher than the other wheels 273, 222, and 275, and the period during which the detection holes 271A and 272A overlap each other lasts for one motor pulse. Therefore, when the pointer positions are detected using the detection holes 271A and 272A, the pointers 2 can be more reliably aligned with the reference position than when the reference position is detected using only the detection holes 273A and 275A, which may continue to overlap between motor pulses. Because of this, the diameters of the detection holes 271A and 272A should be as small as possible while still remaining machinable, and the diameters of the detection holes 273A, 222A, and 275A of the other wheels 273, 222, and 275 may be large enough so as not to hinder light transmission through the detection holes 271A and 272A.

In the present embodiment, the detection opening 271A in the fifth wheel 271 is formed to be larger than the detection opening 272A in the third wheel 272 enmeshed with the fifth wheel, and equal in size to the detection opening 272A in the second wheel 273. Specifically, the diameters of the detection holes 273A and 275A of the second wheel 273 and hour wheel 275 are 0.5 mm, the diameters of the detection holes 272A and 222A of the third wheel 272 and seconds wheel 222 are 0.4 mm, and the detection opening 271A of the fifth wheel 271 has a large diameter of 0.5 mm.

This is because the rotor pinion 261A meshed with the fifth wheel 271 has ten teeth as previously described, and the phase alignment is lost. Specifically, if the phases are misaligned, the amount of misalignment can be compensated for by merely forming a large detection opening 271A in the fifth wheel 271, and there is no longer a need for the phases to be aligned. The same also applies to the seconds intermediate wheel 221.

Furthermore, in the present embodiment, while the hour/minute reduction gear train 27 having the hour and minute hands 2C and 2B, and the seconds hand reduction gear train 22 having the seconds hand 2A, are driven by separate motors 21 and 26, the seconds detection wheel 223 is provided to a position where the wheel does not overlap with the second wheel 273 and hour wheel 275 on which the hour and minute hands 2C and 2B are mounted in the same plane, and the reference position of the seconds hand 2A is detected separately by the photosensor in this position. Therefore, the hour and minute hands 2C and 2B can be efficiently rotated separately from the seconds hand 2A, and be aligned with the reference position. The hour and minute hands 2C and 2B are also driven by a separate hour/minute hand motor 26, which is convenient for correcting time differences, for example.

Since the detection opening 222A of the seconds wheel 222 overlaps the hour/minute-hand position detector, in practice, a certain order must be followed with the two gear trains when detecting the pointer positions. First, the detection opening 222A of the seconds wheel 222 is brought in alignment with the regular phase by detecting the position of the seconds hand reduction gear train 22, and the position of the hour/minute reduction gear train 27 is then detected.

As shown in FIGS. 1 and 2, the date wheel 30 is formed on the main plate 10 and is made to face the side opposite from the side on which the pointer drive device 20 is provided. As shown in FIG. 3, the disc-shaped dial 3 is provided on top of the date wheel 30 (on the paper surface side in FIG. 2), and a window (not shown) for displaying the date is provided along part of the outer periphery of the dial 3, which enables part of the date wheel 30 to be seen through the window as the date. The dial 3 is configured from glass or another light transmitting material, and a solar panel 4 as a power generator for generating electricity by means of irradiated light is disposed between the dial 3 and the main plate 10.

Referring again to FIG. 2, the date wheel 30 is formed in the shape of a ring and is disposed between the solar panel 4 and the main plate 10, and an internal gear 32 is formed on the inner peripheral surface of the date wheel 30. The numerals “1” through “31” for indicating the date are formed by printing in the surface of the dial 3 of the date wheel 30.

As shown in FIG. 1, the calendar drive device 31 is configured from a stepping motor similar to the seconds hand motor 21 and the hour/minute hand motor 26, and the device includes a rotor 311, a stator 312, and a coil 313. The calendar drive device 31 is placed substantially in the 5:00 direction of the timepiece 1, with the rotor 311 disposed in the middle of the main plate 10, and the coil 313 disposed on the outer peripheral side of the main plate 10.

A calendar gear train 33 for transmitting drive force from the calendar drive device 31 to the date wheel 30 is provided between the date wheel 30 and the calendar drive device 31. The calendar gear train 33 includes a date-turning first intermediate wheel 331 enmeshed with a rotor pinion 311A formed integrally on the rotor 311, a date-turning second intermediate wheel 332 enmeshed with the date-turning first intermediate wheel 331, and a date-turning wheel 333 enmeshed with the date-turning second intermediate wheel 332. The date-turning wheel 333 has a gear 333A that passes through the main plate 10 on the side of the dial 3, and this gear 333A meshes with the internal gear 32 of the date wheel 30. Positioning the date wheel 30 in the planar direction is accomplished by meshing with the gear 333A and the internal gear 32, and a jumper such as is used to determine the position of the date wheel in conventional practice is not provided.

When a motor pulse is supplied to the coil 313, a magnetic path is formed in the stator 312 by electromagnetic induction, and the rotor 311 rotates. The rotation is transmitted sequentially to the rotor pinion 311A, the date-turning first intermediate wheel 331, the date-turning second intermediate wheel 332, and the date-turning wheel 333, and the date wheel 30 rotates as a result of the rotation of the date-turning wheel 333 to change the date that is being displayed.

The calendar drive device 31 is disposed nearer to the outer peripheral side (outer side) of the main plate 10 than the pointer drive device 20. As a result, the distance from the rotational center of the rotor 311 of the calendar drive device 31 to the rotational center of the pointers 2 is greater than both distances from the rotational centers of the rotors 211 and 261 of the pointer drive device 20 (seconds hand motor 21 and hour/minute hand motor 26) to the rotational center of the pointers 2.

A battery 40 is accommodated in the power supply storage unit 41. The battery 40 is a secondary battery, and the electromotive force generated by the solar panel 4 is charged to the battery 40. The power supply storage unit 41 is placed substantially in the 1:00 direction of the timepiece 1, and is disposed on the outer peripheral side of the main plate 10.

The power supply storage unit 41 is disposed nearer to the outer peripheral side (the outer side) of the main plate 10 than the pointer drive device 20. As a result, the distance from the substantial center of the power supply storage unit 41 (the center of the circular battery 40) to the rotational center of the pointers 2 is greater than both the distances from the rotational centers of the rotors 211 and 261 of the pointer drive device 20 (seconds hand motor 21 and hour/minute hand motor 26) to the rotational center of the pointers 2.

Antenna 50 includes an antenna core 51, a core storage unit 52 for storing the antenna core 51, and a coil 53 wound around part of the core storage unit 52.

The antenna core 51 is configured by stacking a plurality of amorphous thin plates and is provided with a substantially rectangular straight part 511 formed virtually in the center, and curved parts 512 formed curving in a substantial arc along the outer edge of the main plate 10 at either end of the straight part 511.

The core storage unit 52 is configured from an insulating material, and, similar to the antenna core 51, includes a rod-shaped straight part 521 formed virtually in the center, and curved parts 522 formed curving in a substantial arc along the outer edge of the main plate 10 at either end of the straight part 521. A concavity is formed in the surface of the core storage unit 52 that faces the main plate 10, and the antenna core 51 is accommodated in this concavity. The antenna 50 is fixed in place on the main plate 10 by screwing the core storage unit 52 onto the main plate 10.

The coil 53 is wound around the straight part 521 of the core storage unit 52. Flanges 523 are formed at either end of the straight part 521 of the core storage unit 52, the coil 53 is prevented from unwinding by these flanges 523, and the coil 53 is formed uniformly with a specific number of windings.

A circuit board 54 on which the end of the coil 53 is connected is fixed in place to one of the curved parts 522 of the core storage unit 52. A plurality of capacitors 541 are mounted on the circuit board 54 as electrical elements for adjusting the tuning frequency of the antenna 50. The circuit board 54 on the side of the back lid is electrically conductive with a circuit block 7A (FIG. 5) on the end of the core storage unit 52.

Circuit block 7A includes the aqueous solution light-receiving element 7, as well as the following components (not shown in the diagrams): a timekeeping crystal oscillator for oscillating a reference clock, a CPU, a crystal oscillator for a bandpass filter designed to allow only standard radio wave signals to pass through, and a receiving IC (receiving circuit) for processing the standard radio waves received by the antenna 50. The CPU is configured including a frequency divider circuit for dividing the frequency from the timekeeping crystal oscillator and generating reference blocks, a timekeeping circuit for counting the reference blocks to keep the time, and a control circuit for controlling the pointer drive device 20 and the calendar drive device 31 on the basis of the signals from the timekeeping circuit. Also, the receiving IC is configured including a demodulator circuit for demodulating the standard radio waves received by the antenna 50, and an amplifier circuit for amplifying the received signals.

The external operating device 5 includes a setting stem 5A placed substantially in the 3:00 direction of the timepiece 1, and buttons (not shown) placed substantially in the 2:00 and 4:00 direction of the timepiece. The setting stem 5A has a switching function that enables switching among a plurality of modes depending on how far the stem is pulled out; for example, pulling out the setting stem 5A by one step results in a manual correction mode for the date wheel 30, in which the date wheel 30 can be rotated by pushing the buttons. Pulling the setting stem 5A out by two steps, for example, results in a time correction mode, in which the pointers 2 can be rotated by pushing the buttons.

Information can be displayed by pushing the buttons, and if the buttons are pushed while the setting stem 5A is not pulled out, for example, information pertaining to the reception of the previous standard radio waves (whether they have been received) is displayed. The display of reception results is set so that the seconds hand 2A is at the 10-second mark when reception is complete, for example, and the seconds hand 2A is at the 20-second mark when reception has failed. The results of reception continue to be displayed for a specific amount of time (for example, five seconds), and after the specific time has elapsed, the seconds hand 2A returns to its original position, and the current time is displayed. When the reception of standard radio waves is initiated by operating the buttons, this operation can be accompanied by a display that indicates whether the standard radio waves are in a receivable range by means of the position of the seconds hand 2A.

When assembling the timepiece 1, first the main plate 10 is placed on an assembly jig 700, as shown in FIG. 5. A positioning pin 600 (double-dashed line) provided to the assembly jig 700 is caused to pass through the light transmitting opening 10A in the main plate 10. The second wheel 273, the third wheel 272, the fifth wheel 271, and the seconds wheel 222 are then disposed sequentially on the main plate 10. At this time, the detection holes 273A, 272A, 271A, and 222A are engaged with the positioning pin 600. Although not shown in the diagram, the minute wheel 274 is disposed while a positioning opening 274A (FIG. 4) provided to the minute wheel 274 is engaged with a specific positioning pin.

Similarly, the seconds intermediate wheel 221 and the seconds detection wheel 223 are also disposed while detection holes 221A and 223A provided thereto are engaged with a specific positioning pin. A positioning pin other than the positioning pin 600 is used to mount the hour hand 2C, the minute hand 2B, and the seconds hand 2A (FIG. 3) so that they are in the 12:00 position when the arrangement of all the wheels 271, 272, 273, and 222 is complete. The pointers 2 are thereby aligned with the reference position, that is, the 12:00 position, in a state in which light is transmitted through the detection holes 271A, 272A, 273A, 222A, 221A, and 223A. The hour wheel 275 is disposed on the side of the main plate 10 facing the dial 3, and is therefore disposed using another positioning device after the movement being assembled is removed from the positioning pin 600. In practice, the hour wheel 275 is incorporated at a position where the detection opening 273A of the second wheel 273 neatly overlaps the detection opening 275A of the hour wheel 275 as a guide.

[Configuration of the Control Device]

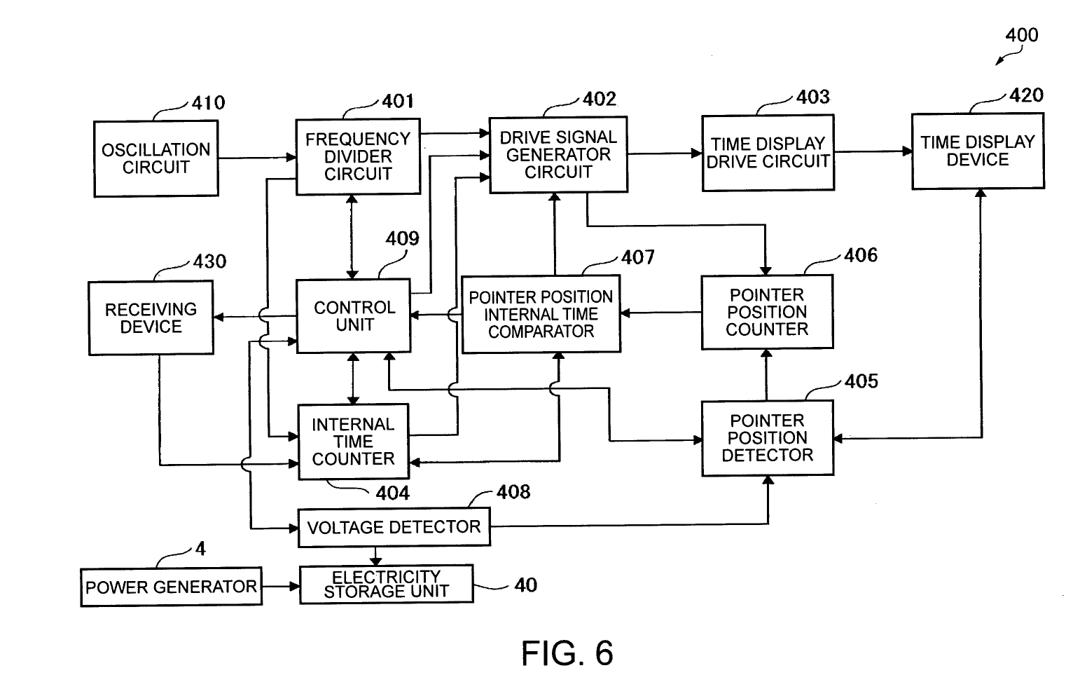

Next, the configuration of the control device for controlling the operation of the timepiece 1 will be described with reference to FIG. 6.

A control device 400 (control means) has a circuit configuration in which, for example, an IC (integrated circuit) and various electrical components are installed, and is obtained by performing the timekeeping and time correction functions of the timepiece 1.

Specifically, the control device 400 includes a frequency divider circuit 401, a drive signal generator circuit 402 (drive signal generation means), a time display drive circuit 403, an internal time counter 404 (internal time counter means), a pointer position detector 405 (time display member detection means), a pointer position counter 406 (time display member position detection means), a pointer position internal time comparator 407 (adjustment means), and a control unit 409.

The control unit 409 controls the frequency divider circuit 401, the drive signal generator circuit 402, a receiving device 430, the internal time counter 404, the pointer position internal time comparator 407, the pointer position detector 405, and the voltage detector 408 (voltage detection means). The specific control method will be described later.

The frequency divider circuit 401 is controlled by the control unit 409 and is made to divide the oscillation signals that are output from an oscillation circuit 410 and to output signals having a specific frequency. For example, the frequency divider circuit 401 outputs divided pulse signals of 1 Hz to the drive signal generator circuit 402, the internal time counter 404, and the control unit 409.

The oscillation circuit 410 is a conventional device that causes a crystal oscillator or another drive signal source to oscillate at a high frequency and outputs an oscillation signal created by this high frequency oscillation. Therefore, no description is necessary.

The drive signal generator circuit 402 is a circuit that generates signals for driving the time display drive circuit 403.

The time display drive circuit 403 (time display member drive means) is a circuit for driving a time display device 420. The time display device 420 of the present embodiment is an analog-type time display device that has motors 21 and 26, a calendar drive device (calendar motor) 31, pointers 2, and a date wheel 30. The time display members for indicating time information are configured from the pointers 2 and the date wheel 30, and the time display member drive device (time display member drive means) for driving the time display members is configured from the seconds hand motor 21, the hour/minute hand motor 26, and the calendar drive device (calendar motor) 31. The time display drive circuit 403 controls the driving of the seconds hand motor 21, the hour/minute hand motor 26, and the calendar drive device (calendar motor) 31.

The internal time counter 404 is configured from various counters; for example, a preset counter or the like for storing time codes. Time data received by the receiving device 430 is stored in the internal time counter 404, and this stored time data is updated based on a signal from the frequency divider circuit 401. As a result, current time information indicating the current time is constantly stored and counted in the internal time counter 404.

The receiving device 430 receives standard radio waves containing time data. Specifically, the receiving device 430 includes an antenna 50 and a tuning circuit configured from a tuning capacitor or the like. The receiving device 430 is controlled by the control unit 409, and is configured so that low-frequency standard radio waves whose frequency is set by the tuning circuit are received by the antenna 50. The low-frequency standard radio waves received have two frequencies: the standard radio wave output channel of “Otakadoya-yama (Eastern Japan),” which is a transmission frequency of 40 kHz, and the standard radio wave output channel of “Hagane-yama (Western Japan),” which is a transmission frequency of 60 kHz.

Also, the receiving device 430 includes (not shown) an amplifier circuit, a bandpass filter, a demodulator circuit, and a decoder circuit. The device extracts time information, that is, a time code, which is digital information, from the received low frequency radio waves. This extracted time code is output to the internal time counter 404.

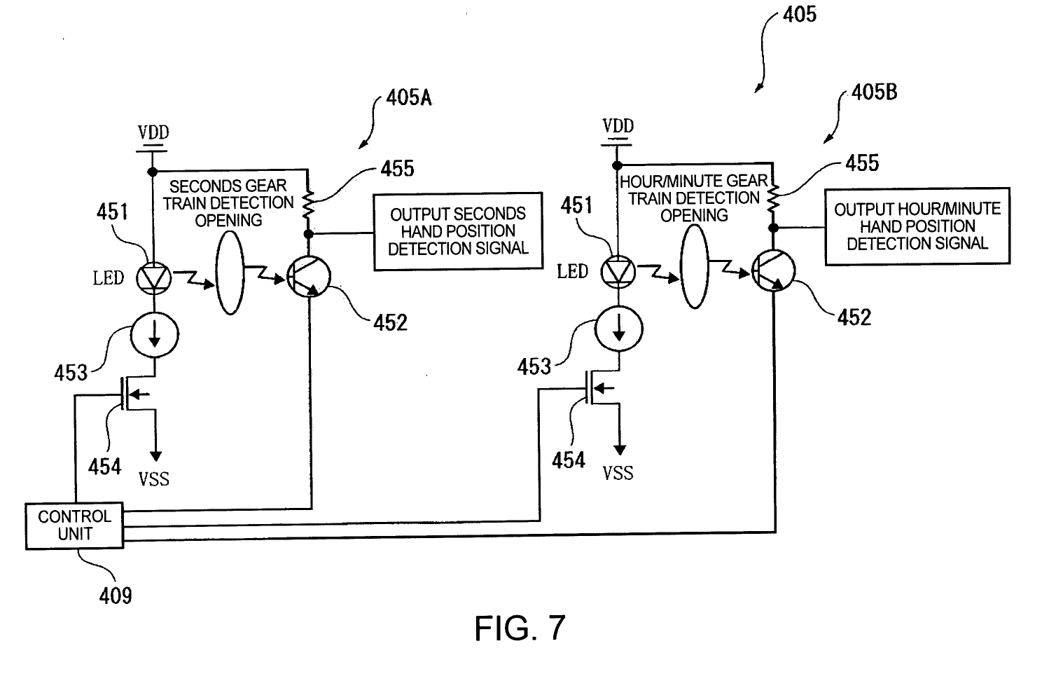

The pointer position detector 405, which is the time display member position detector, includes a seconds-hand position detector 405A for detecting the position of the seconds hand 2A and outputting a seconds hand position detection signal, and an hour/minute-hand position detector 405B for detecting the positions of the minute hand 2B and hour hand 2C, and outputting an hour/minute hand position detection signal, as shown in FIG. 7.

The seconds-hand position detector 405A and the hour/minute-hand position detector 405B include a light emitting diode (LED) 451 as the light-emitting element 6, and a phototransistor 452 as the light-receiving element 7.

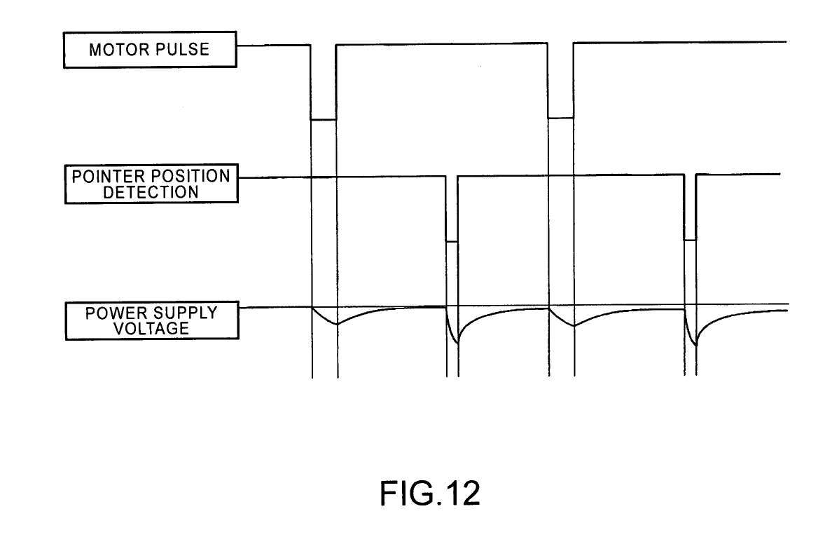

The control unit 409 moves the gear train for the seconds hand and the hour and minute hands by one step, then changes the emitter of the phototransistor 452 from VDD to VSS after the gear train has completed moving to enable light reception, and turns on a transistor 454, which is the switch of a constant current source 453, to supply a constant electric current to LED 451 and to cause LED 451 to emit light. Specifically, in the present embodiment, a pulse signal for driving the pointer position detector 405 to detect the pointer positions is output between each drive pulse from the stepping motor so that the output timing does not overlap the output timing of the drive pulse of the stepping motor, as shown in FIG. 12.

Depending on the phase of the gear train, when the detection holes overlap, the light from the LED 451 is directed to the phototransistor 452, and an electric current is supplied to the phototransistor 452. Detection signals are then output from the seconds-hand position detector 405A and the hour/minute-hand position detector 405B, and the pointer positions are detected.

In the present embodiment, the seconds-hand position detector 405A outputs a seconds hand position detecting signal when the seconds hand 2A is at the O-seconds position, and the hour/minute-hand position detector 405B outputs a detection signal when the minute hand 2B and hour hand 2C are in the 0:00 am position or the 0:00 pm position.

The resistance value of a resistor 455 connected to the phototransistor 452 may be optimized for both the seconds-hand position detector 405A and the hour/minute-hand position detector 405B. Also, if the settings of the resistance values match, a common resistance value can be used for both detection devices 405A and 405B.

The pointer position counter 406 is reset every time a pointer position detection signal is received from the pointer position detector 405, and counts the drive signals from the drive signal generator circuit 402. The count of the pointer position counter 406 is controlled so as to correspond with the positions of the pointers 2. Therefore, the time display member position counter of the present invention is configured from the pointer position counter 406.

The pointer position internal time comparator 407 compares the internal time data (current time data) counted by the internal time counter 404 with the pointer position data counted by the pointer position counter 406, and either corrects the internal time counter 404 or corrects the pointers 2 and the pointer position counter 406 when the data does not coincide.

The voltage detector 408 detects the voltage of an electricity storage unit 40 in which electrical energy generated by a power generator 440 is stored, and outputs a voltage detection signal indicating the voltage value. This voltage detection signal is output to the control unit 409 and the pointer position detector 405.

The control unit 409 instructs the pointer position detector 405 to terminate the pointer position detection routine or to change the pointer position detecting method according to the voltage (power supply voltage) of the battery (electricity storage unit) 40 as the power supply detected by the voltage detector 408.

The power generator (solar panel) 4 is a solar power generator (solar battery) that takes in sunlight or another external energy source and converts it into electrical energy. The power generator 4 is not limited to a solar panel, and can also be configured from an electromagnetic power generator, a thermal power generator, a piezo power generator, or any other power generator that converts the drive force of the rotary spindle to electricity.

The timepiece 1 operates in the following manner.

The oscillation signal output form the oscillation circuit 410 is divided by the frequency divider circuit 401 of the control device 400, and a drive signal is generated by the drive signal generator circuit 402. The pointer position data is counted by the pointer position counter 406 on the basis of this drive signal, and the seconds hand motor 21 and hour/minute hand motor 26 are driven. The rotational movement of the seconds hand motor 21 and hour/minute hand motor 26 is transmitted to the seconds hand 2A, the minute hand 2B, and the hour hand 2C via the seconds hand reduction gear train 22 and the hour/minute reduction gear train 27, and the time is displayed on the dial 3 of the timepiece 1 by the rotation of pointers 2.

When standard radio waves that contain time data are received by the antenna 50, the receiving device 430 extracts the time data from the standard radio waves and outputs the data to the internal time counter 404. The control unit 409 corrects the pointer position data timed by the pointer position counter 406 on the basis of this time data, and drives the seconds hand motor 21 and hour/minute hand motor 26 to correct the time displayed by the pointers 2.

Furthermore, when 24 hours are counted by the timekeeping circuit in the CPU, the CPU drives the calendar drive device 31 and changes the date wheel 30 by one day.

Also, the timepiece 1 performs pointer position detection routine in which the positions of the pointers 2 are corrected with a specific preset timing.

[Pointer Position Detection Routine]

The operation for detecting the positions of the pointers in the timepiece 1 will now be described.

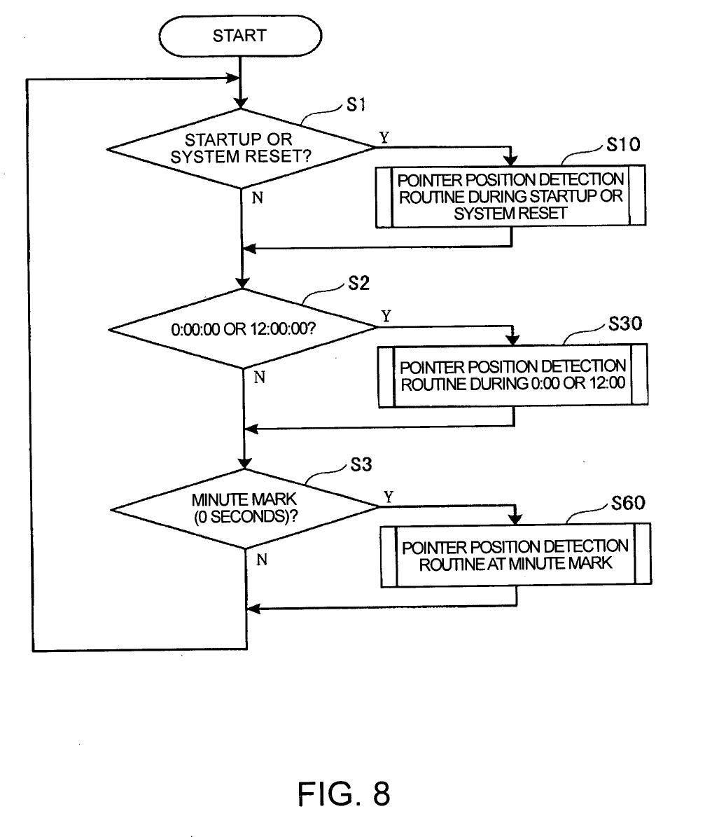

The control unit 409 of the timepiece 1 detects when the timepiece 1 starts up or when the system is reset (step 1, the word “step” is hereinafter abbreviated as “S”), and executes a pointer position detection routine during a startup or a system reset (S10), as shown in FIG. 8.

Also, the control unit 409 determines whether the internal time (present time) counted by the internal time counter 404 is 0:00 or 12:00 (S2) and executes a 0:00 or 12:00 pointer position detection routine (S30) if this time is detected.

Furthermore, the control unit 409 determines whether the internal time (current time) counted by the internal time counter 404 is at the minute mark, or at 0 seconds (S3) and executes a routine for detecting the position of the minute mark pointer (S60) if this time is detected.

Specifically, when the timepiece 1 is started up or reset, the pointer positions must be detected because the pointer position counter 406 does not have the pointer position information. Therefore, the control unit 409 executes the pointer position detecting routine S10 when the timepiece 1 is started up or reset.

Also, the control unit 409 detects the positions of the hour hand 2C and minute hand 2B to be at the 12-hour mark during regular pointer movement, and detects the position of the seconds hand 2A to be at the one minute mark.

[Pointer Position Detection Routine During Startup or System Reset]

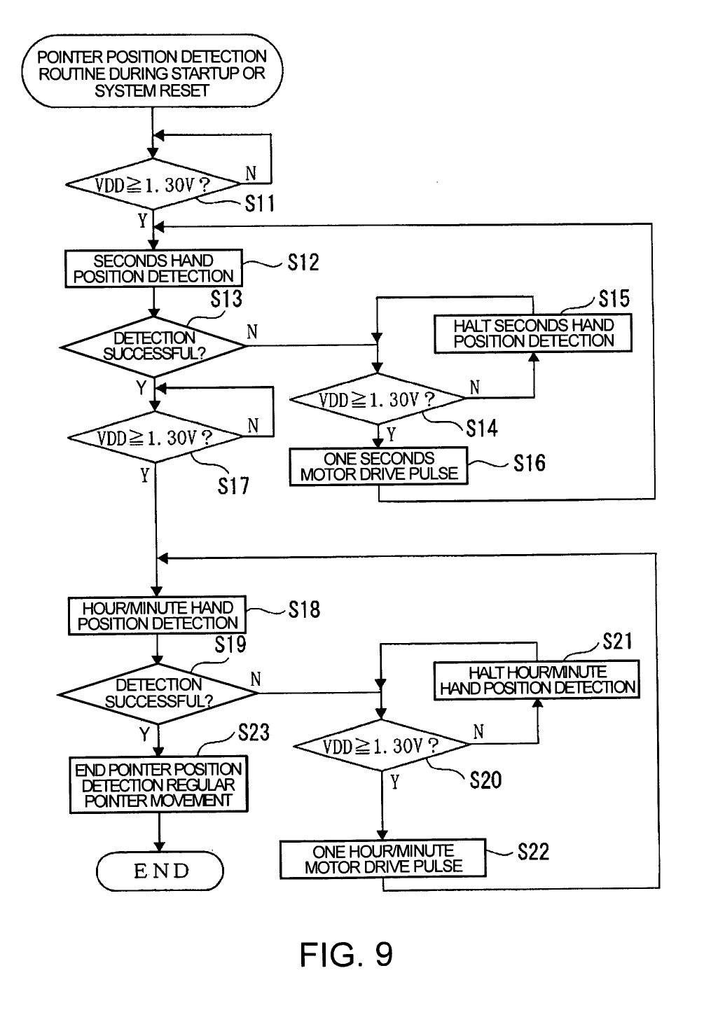

Next, the pointer position detecting routine S10 during a startup or a system reset will be described with reference to FIG. 9.

In the pointer position detecting routine S10, first, the control unit 409 uses the voltage detector 408 to determine whether the voltage of the electricity storage unit 40 (the power supply voltage VDD) is equal to or greater than a specific voltage (1.30 V in the present embodiment) (S11).

If the power supply voltage VDD is less than the specific voltage (1.30 V) in S11, the control unit 409 repeats the power supply voltage detection process until the power supply voltage VDD is equal to or greater than the specific voltage.

If the power supply voltage VDD is equal to or greater than the specific voltage in S11, the control unit 409 operates the pointer position detector 405 and executes the pointer position detection routine. In the present embodiment, the seconds-hand position detector 405A is first operated, and a process of detecting the position of the seconds hand 2A is performed (S12). Specifically, the control unit 409 controls the transistor 454 of the seconds-hand position detector 405A and causes the LED 451 to emit light. At this time, the light is detected by the phototransistor 452, and the seconds-hand position detector 405A outputs a seconds hand position detection signal only when the detection opening in the seconds gear train is positioned between the LED 451 and the phototransistor 452.

In the routine S12 for detecting the position of the seconds hand, the control unit 409 determines whether the seconds hand 2A has been detected in the 0-seconds position depending on whether the seconds hand position detecting signal has been output (S13).

When the seconds hand position detection signal has not been output, the control unit 409 again detects whether the power supply voltage VDD is equal to or greater than the specific voltage (S14). If the power supply voltage VDD is less than the specific voltage, the control unit 409 halts the routine for detecting the position of the seconds hand until the power supply voltage VDD is equal to or greater than the specific voltage due to electrical charging (S15).

When the power supply voltage VDD is detected as being equal to or greater than the specific voltage in S14, the control unit 409 outputs one drive signal (one pulse) via the drive signal generator circuit 402 and drives the seconds hand motor 21 by one step (S16).

When the seconds hand 2A is driven, the control unit 409 again executes the process of detecting the position of the seconds hand 2A (S12) and determines whether the seconds hand 2A can be detected (S13).

If the process in S12 through S16 is repeated, the seconds hand 2A is detected in S13 while the seconds hand 2A moves by one cycle (60 seconds).

When the seconds hand 2A is detected in S13, the control unit 409 again detects whether the power supply voltage VDD is equal to or greater than the specific voltage (S17), and the power supply voltage detection process is repeated until the voltage is equal to or greater than the specific voltage (1.30 V in the present embodiment).

When the power supply voltage VDD is equal to or greater than the specific voltage in S17, the control unit 409 operates the hour/minute-hand position detector 405B and performs a process of detecting the positions of the minute hand 2B and the hour hand 2C (S18). Specifically, the control unit 409 controls the transistor 454 of the hour/minute-hand position detector 405B and causes the LED 451 to emit light. At this time, the light is detected by the phototransistor 452, and the hour/minute-hand position detector 405B outputs an hour/minute hand position detection signal only when the detection opening in the hour/minute gear train is positioned between the LED 451 and the phototransistor 452.

In the hour/minute hand position detecting routine S18, the control unit 409 determines whether the hour hand 2C and the minute hand 2B have been detected to be in the 0-hour/0-minute position (or the 12-hour/0-minute position) depending on whether the hour/minute hand position detecting signal has been output (S19).

When the hour/minute hand position detection signal has not been output, the control unit 409 detects whether the power supply voltage VDD is equal to or greater than the specific voltage (S20), similar to steps S14 through S16, and halts the hour/minute hand position detection routine until the power supply voltage VDD is equal to or greater than the specific voltage (S21).

When the power supply voltage VDD is detected as being equal to or greater than the specific voltage in S20, the control unit 409 outputs one drive signal via the drive signal generator circuit 402, drives the hour/minute hand motor 26 by one step, and moves the hour/minute hand by one step (S22).

When the hour and minute hands 2B and 2C are driven, the control unit 409 again executes the hour/minute hand position detection routine (S18), and repeats steps S18 through S22 until the hour and minute hands are detected.

When the hour and minute hands are detected in S19, the control unit 409 ends the pointer position detection routine and returns to regular pointer movement (S23).

When the seconds hand position detection signal is output from the pointer position detector 405 in S12, the seconds hand 2A is stopped at the 0-seconds position. Therefore, the pointer position counter 406, having received the seconds hand position detection signal, resets the internally provided seconds hand position counter to 0 and ensures that the counted value of the seconds hand position counter and the position of the seconds hand 2A are synchronized.

Similarly, when the hour/minute hand position detection signal is output in S18, the hour and minute hands 2B and 2C stop in the 0-hour/0-minute position, and the pointer position counter 406 resets the internally provided hour/minute hand position counter to ensure that the counted value of the hour/minute hand position counter and the positions of the hour and minute hands 2B and 2C are synchronized.

Also, after returning to regular pointer movement in S23, the control unit 409 outputs a drive signal from the drive signal generator circuit 402 to the time display drive circuit 403 and the pointer position counter 406, and speeds up the pointers 2 to move them to the current time until the counted value of the pointer position counter 406 matches the counted value of the internal time counter 404 according to the pointer position internal time comparator 407. Regular pointer movement is thereafter conducted according to the input of the drive signal from the frequency divider circuit 401.

[0:00 or 12:00 Pointer Position Detection Routine]

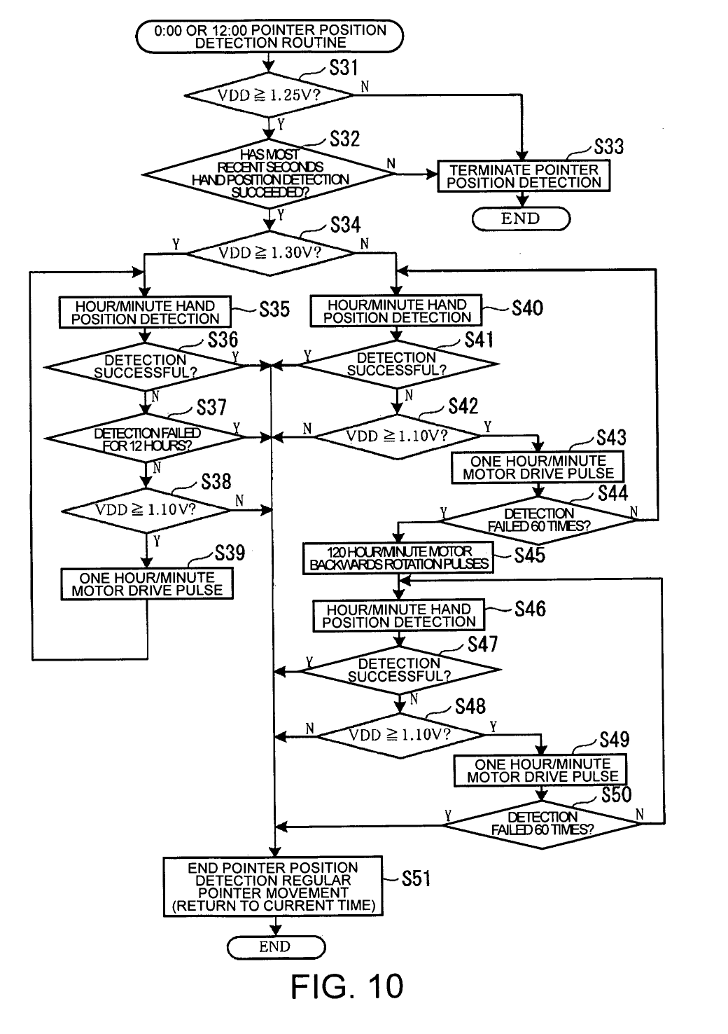

Next, the routine S30 for detecting the 0:00 or 12:00 pointer position will be described with reference to FIG. 10.

When the routine S30 for detecting the pointer position is executed, the control unit 409 first detects whether the power supply voltage VDD is equal to or greater than the specific voltage (1.25 V in the present embodiment) (S31).

If the power supply voltage VDD is equal to or greater than the specific voltage in S31, the control unit 409 confirms whether the positions have been successfully detected (S32) in the most recent routine for detecting the position of the seconds hand (routine for detecting the position of the seconds hand at the minute mark) S60. The control unit 409 then terminates the current routine for detecting the position of the seconds hand (S33) if the position detection has failed in the most recent routine for detecting the position of the seconds hand or if the power supply voltage VDD is less than the specific voltage in S31, and ends the routine S30 for detecting the 0:00 or 12:00 pointer position.

When the positions have been successfully detected in the most recent seconds hand position detecting routine S60, the control unit 409 confirms whether the power supply voltage VDD is equal to or greater than a second specific voltage (1.30 V in the present embodiment) (S34).

If the determination in S34 is “Y,” the control unit 409 executes the hour/minute hand position detection routine (S35), and confirms whether the hour and minute hands 2B and 2C have could be detected (S36).

This hour/minute hand position detecting routine S35 is executed when the internal timepiece (internal time counter 404) is at 0:00 or 12:00, and therefore normally the hour and minute hands 2B and 2C are detected and the determination in S36 is “Y.” In this case, the control unit 409 detects whether the hour and minute hands 2B and 2C are in the correct positions, ends the pointer position detection routine, returns to displaying the current time and to regular pointer movement (S51), and ends the routine S30 for detecting the 0:00 or 12:00 pointer position.

If the hour and minute hands 2B and 2C could not be detected in S36, this means that the hour and minute hands 2B and 2C are out of alignment with the internal timepiece, and so the hour and minute hands 2B and 2C are moved by one step each and position detection is performed each time.

Specifically, first it is determined whether the detection of the hour and minute hands 2B and 2C has failed over the course of 12 hours in the time indicated by the hour and minute hands 2B and 2C (S37). When detection has failed for 12 hours, that is, when the hour and minute hands 2B and 2C have moved for 12 hours but could not be detected, the pointer position detection routine is ended (S51). Normally, the hour and minute hands 2B and 2C can be reliably detected if the hour and minute hands 2B and 2C are moved for 12 hours, but if the timepiece 1 is in an environment with an extremely low temperature, for example, the amount of light from the LED 451 decreases when the power supply voltage is low, which results in detection errors and the like, and sometimes the hour and minute hands 2B and 2C cannot be detected. In such cases, the pointer position detection routine is ended (S51) because it is highly possible that detection will be impossible even if the pointer position detection routine is continued.

If the determination in S37 is “N” and the hands have not completed a 12-hour cycle, the control unit 409 confirms whether the power supply voltage VDD is equal to or greater than a specific voltage (1.10 V) (S38). If the power supply voltage VDD is less than the specific voltage, the control unit 409 ends the pointer position detection routine (S51).

On the other hand, if the power supply voltage VDD is equal to or greater than the specific voltage, the control unit 409 outputs one drive signal for driving the hour/minute hand motor 26 and moves the hour/minute hand motor 26 by one step (S39). In the present embodiment, the minute hand 2B is set so as to be moved by one minute in 12 steps. In other words, the minute hand 2B is set so as to complete a full rotation (360 degrees) in 720 steps, and rotates by only 0.5 degrees with one step. The hour hand 2C is rotated by the hour/minute gear train in conjunction with the minute hand 2B.

When the hour and minute hands 2B and 2C are driven in S39, the control unit 409 again executes the hour/minute hand position detecting routine S35. When the control unit 409 repeats the process in steps S35 through S38 and the hour and minute hands 2B and 2C are driven in S36, the pointer position detection routine is ended and the pointers return to the current time and to regular pointer movement (S51) if detection has failed for 12 hours in S37 and if the power supply voltage VDD is less than the specific voltage in S38.

Also, when the determination in S34 is N, that is, when the power supply voltage VDD is equal to or greater than 1.25 V (“Y” in S31) and less than 1.30 V (“N” in S34), then the control unit 409 executes the hour/minute hand position detection routine (S40) and confirms whether the hour and minute hands 2B and 2C could be detected (S41), similar to S35 and 36.

If the determination in S41 is that the hands could not be detected, then the control unit 409 confirms whether the power supply voltage VDD is equal to or greater than the specific voltage (1.10 V) (S42), and if the power supply voltage VDD is equal to or greater than the specific voltage, the control unit outputs one drive pulse for driving the hour/minute hand motor 26 and moves the hour/minute hand motor 26 by one step (S43).

Next, the control unit 409 determines whether detection has failed (no detection) in the hour/minute hand position detecting routine S40 60 times (S44), and repeats the hour/minute hand position detecting routine S40 through S44 if it is less than 60 times. When drive signals have been input 60 times to the hour/minute hand motor 26, the minute hand 2B moves by 30 degrees (equivalent to 5 minutes in terms of time). Therefore, when detection is determined to have failed 60 times in S44, the result is that the hour and minute hands 2B and 2C could not be detected even though the minute hand 2B has moved 30 degrees.

In the routine of S40 through S44, when the hour and minute hands 2B and 2C have been detected (“Y” in S41) and the power supply voltage VDD is less than the specific voltage (“N” in S42), the control unit 409 ends the pointer position detection routine and returns the pointers to the current time and to regular pointer movement (S51).

Also, when detection has failed 60 times in S44, the control unit 409 outputs 120 drive signals for rotating the hour/minute hand motor 26 in the opposite direction, and moves the hour and minute hands 2B and 2C by 10 minutes (60 degrees) (S45).

The control unit 409 then executes the routine S46 for detecting the hour/minute hand position, the routine S47 for detecting the hour/minute hand, the routine S48 for determining the power supply voltage, the routine S49 for driving the hour/minute hand motor 26, and the routine S50 for determining detection failure 60 times, similar to S40 through S44.

If the hour and minute hands 2B and 2C have been detected in S41 and 47, the power supply voltage VDD is less than the specific voltage (1.10 V) in S42 and 48, and detection has failed 60 times in S50, then the control unit 409 ends the pointer position detection routine and returns the pointers to the current time and to regular pointer movement (S51).

When the pointer position detection routine ends in S51 and regular pointer movement is resumed, the routine S30 for detecting the 0:00 or 12:00 pointer position also ends.

[Routine for Detecting the Position of Minute Mark Pointer]

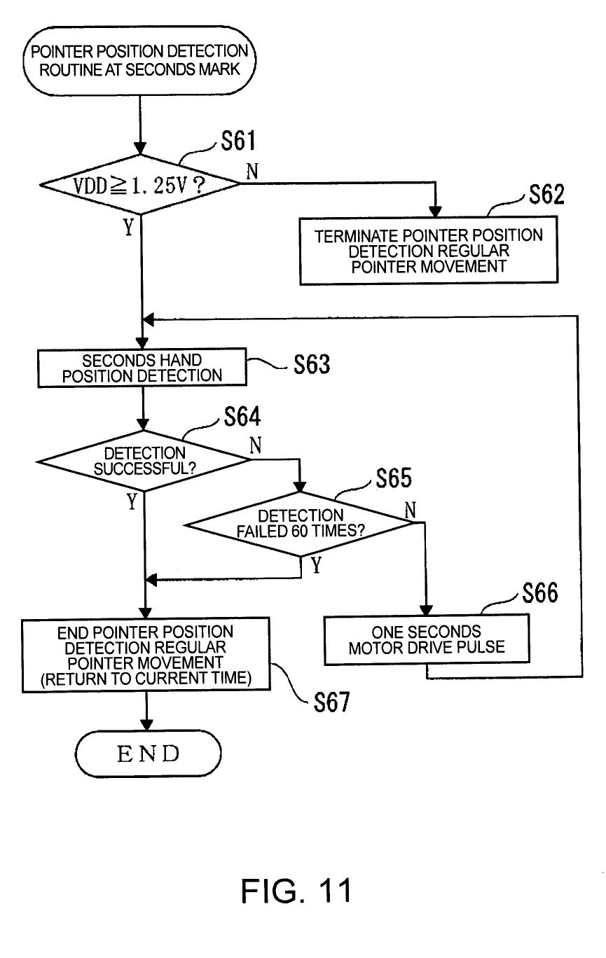

Next, the routine S60 for detecting the position of the minute mark pointer will be described with reference to FIG. 11.

When the routine S60 for detecting the pointer position is executed, the control unit 409 first detects whether the power supply voltage VDD is equal to or greater than a specific voltage (1.25 V in the present embodiment) (S61).

If the power supply voltage VDD is less than the specific voltage, the control unit 409 terminates the current pointer position detection routine and continues regular pointer movement (S62).

On the other hand, if the power supply voltage VDD is equal to or greater than the specific voltage, the control unit 409 executes a routine for detecting the position of the seconds hand (S63). The routine S63 for detecting the position of the seconds hand is similar to the routine S12 for detecting the position of the seconds hand in FIG. 9, and a description thereof is omitted.

The control unit 409 determines whether the seconds hand 2A could be detected in S63 (S64), and if the seconds hand 2A could not be detected, the control unit continues moving the seconds hand 2A by driving the seconds hand motor 21 (S66) and repeats the routine S63 for detecting the position of the seconds hand until detection has failed 60 times (S65).

When the seconds hand 2A is detected in S64 or when detection has failed 60 times in S65, the control unit 409 ends the routine for detecting the position of the seconds hand and resumes regular pointer movement (S67). Resuming regular pointer movement involves first returning the pointers to the current time on the basis of the pointer position information counted by the pointer position counter 406 and the current time information counted by the internal time counter 404, and then conducting the regular pointer movement routine.

In the present embodiment, every time a drive signal is output from the time display drive circuit 403 to the seconds hand motor 21, the seconds hand 2A moves one step in one second, at which time the routine S23 for detecting the position of the seconds hand is executed. Therefore, this means that when detection has failed 60 times in S25, the seconds hand 2A could not be detected even though the seconds hand 2A has rotated a full cycle (60 seconds). The reason that the position of the seconds hand 2A could not be detected even though it has rotated a full cycle may be that the power supply voltage VDD had decreased and a detection error occurred as a result of the routine S23 for detecting the position of the seconds hand or the routine S26 for driving the seconds hand, or that the LED 451 or phototransistor 452 had failed, for example. Therefore, in the present embodiment, the routine for detecting the position of the seconds hand is ended when detection has failed 60 times in S65 so as to ensure that the routine for detecting the position of the seconds hand does not continue any further.

In the routine S60 for detecting the position of the minute mark pointer, it is possible to perform only the routine for detecting the position of the seconds hand 2A, which results in a lower energy consumption and a smaller decrease in voltage than the routine for detecting the positions of the hour and minute hands 2B and 2C. Therefore, the specific voltage value with which the power supply voltage VDD is compared in S61 is lower than the specific voltage value in the position detecting routine S11 for the hour and minute hands 2B and 2C. Also, since the decrease in voltage is smaller with the routine for detecting the position of the seconds hand 2A, it is sufficient to detect the power supply voltage only once at the start of the minute mark (at 0 seconds), and to not detect the power supply voltage while steps S63 through S66 are being repeated.

According to the present embodiment, the following effects are achieved.

(1) It is possible that detection errors will occur due to a decrease in the amount of light from the LED 451 or other problems, leading to wasteful energy consumption even if the pointer position detection routine is performed with a low power supply voltage VDD, but in the present embodiment, the pointer position detection routine is performed only with a high power supply voltage VDD that is equal to or greater than the specific voltage, and errors in detecting the pointer positions and wasteful energy consumption can therefore be prevented to ensure energy conservation.

Particularly, in the pointer position detection routines S10 and S30, since the power supply voltage VDD is detected every time the pointers are driven and the position detection routine is performed during the routine for detecting the positions of the hour and minute hands 2B and 2C, which has a high possibility of a greater decrease in voltage than the routine for detecting the position of the seconds hand 2A that relies on an optical sensor and on driving the pointers 2, the pointer position detection routine can be executed with a high power supply voltage, errors in detecting the pointer positions can be reliably prevented, and wasteful energy consumption can also be reliably prevented.

(2) Also, the pointer position detection routine and the motor driving routine for detecting the pointer positions are executed when the power supply voltage VDD is equal to or greater than the specific voltage, and the power supply voltage VDD does not decrease greatly as a result of these routines. Therefore, system failures in the timepiece 1 and operating errors in the IC or CPU can be prevented.

(3) Since the pointer position detection routine and the motor driving routine for detecting the pointer positions are performed only when the power supply voltage VDD is equal to or greater than the specific voltage, the capacitance of the backup capacitor can be reduced, and the size and thickness of the timepiece 1 can be reduced accordingly.

(4) The position of the seconds hand 2A at the minute mark or at one minute intervals is confirmed and the positions of the hour and minute hands 2B and 2C are confirmed every 12 hours by the routines S30 and S60 for detecting the pointer position, and when the positions are out of alignment and cannot be detected, the positions of the pointers 2 are detected. Therefore, if the positions of the pointers 2 are misaligned, the misalignment can be detected and corrected immediately. Accordingly, in a radio controlled watch 1 with high time indicating precision, the precision of the pointers 2 can be further improved.

(5) In the routine S30 for detecting the 0:00 or 12:00 pointer position, when the power supply voltage VDD is equal to or greater than 1.30 V and the internal timepiece is at 0:00 or 12:00, if the hour and minute hands 2B and 2C cannot be detected, the hour and minute hands 2B and 2C are rotated for 12 hours and the hour and minute hands 2B and 2C are detected in S35 through S39. Therefore, the hour and minute hands 2B and 2C can be reliably detected except for when the amount of light from the LED 451 decreases and detection errors occur because the light sensor failed or the timepiece is being used in extremely low temperatures. Also, since the hour and minute hands 2B and 2C are moved for 12 hours only when the power supply voltage VDD is high, system failures due to large decreases in the power supply voltage VDD can be prevented even when processes with large energy consumption, such as the pointer position detection routine, are executed while the hour and minute hands 2B and 2C are moved for 12 hours.

(6) Also, in the routine S30 for detecting the 0:00 or 12:00 pointer position, if the power supply voltage VDD is equal to or greater than 1.25 V and less than 1.30, and the hour and minute hands 2B and 2C cannot be detected, the hour and minute hands 2B and 2C are rotated forwards and backwards by five minutes each, and the hour and minute hands 2B and 2C are detected in S40 through S50. Therefore, system failures due to large decreases in the power supply voltage VDD can be prevented because the range of detecting the pointer positions can be narrowed and the energy consumption of the pointer position detection routine can be reduced.

(7) Also, in S40 through S44, when the hour and minute hands 2B and 2C cannot be detected even if the minute hand 2B is advanced by five minutes, the minute hand is rotated backwards by ten minutes in S45, and the hour and minute hands 2B and 2C are then detected while the minute hand 2B is advanced by five minutes in S46 through S50. Therefore, the hour and minute hands 2B and 2C can be detected in a stable manner while the hour and minute hands 2B and 2C are constantly rotated forward.

Specifically, when the hour and minute hands 2B and 2C are rotated backwards, the static stable position of the gear train is somewhat changed from forward rotation due to a backlash effect, and therefore the position where the detection holes overlap also changes and the possibility increases that stable detection will not be possible. In the present embodiment, however, stable detection can be performed because the pointer position detection routine is always performed while the pointers are rotated forward.

(8) In a timepiece 1 that has a pointer position detecting function, the positions of the hour and minute hands 2C and 2B are detected using detection holes 271A and 272A provided to a third wheel 272 and a fifth wheel 271 meshed with a rotor pinion 261A, particularly on the side of the hour/minute reduction gear train 27, and therefore there is no need for concern that the detection holes 271A and 272A will continue to overlap in the fifth wheel 271 and third wheel 272, which have a large angle of rotation, even when the hour/minute hand motor 26 continually advances in steps. Precision of detection can be improved and the pointers 2 can be correctly aligned with the reference position.

(9) Moreover, since the fifth wheel 271 and third wheel 272 are arranged in a concentrated manner at positions in which planar superposition is provided even for the centrally located second wheel 273, space efficiency can be improved, and the layout of the hour/minute reduction gear train 27 can be prevented from expanding in the radial direction to reduce the size of the timepiece 1.

(10) Also, since the seconds hand 2A mounted on the seconds wheel 222 and the hour and minute hands 2C and 2B mounted on the hour wheel 275 and second wheel 273 are driven by separate gear trains 22 and 27, the hour and minute hands 2C and 2B and the seconds hand 2A can be separately driven and aligned with the reference position, and position alignment can be achieved in a short amount of time. Also, since the light-emitting element 6 and light-receiving element 7 used to detect the positions of the hour and minute hands 2C and 2B and the seconds hand 2A are provided separately, the detection circuits can be simplified and reliability can be improved.

(11) In a timepiece 1 with a 12-hour display, the hour wheel 275 is rotated in 12 hour cycles. Therefore, in the present embodiment in which the hour wheel 275 is used to detect the pointer positions, a 12 hour cycle can also be used for the timing with which light is transmitted through the detection holes 271A, 272A, 273A, 222A, and 275A of the five wheels 271, 272, 273, 222, and 275; one location in the display section can be used as the reference position of the pointers 2, such as the exact 12:00 position; and various controls based on the reference position can be simplified.

(12) Furthermore, since the rotor pinions 211A and 261A have ten teeth, which is more than in a regular quartz timepiece, there is virtually no effect on the detection holes 221A and 271A of the seconds intermediate wheel 221 or the fifth wheel 271 meshing with the rotor pinions 211A and 261A even if the phases of the rotor magnets 211B and 261B and of the rotor pinions 211A and 261A have maximum misalignment, and the rotors 211 and 261 can be easily assembled without any regard for the phases.

(13) Another feature of the present embodiment is that the minute hand 2B is moved by five seconds, the number of teeth in the hour/minute reduction gear train 27 can be increased accordingly by using the fifth wheel 271 and the third wheel 272, and the rate of deceleration can be increased. Therefore, the second wheel 273 can retain twice the torque as when a gear train that moves in ten seconds is used, a larger minute hand 2B can be reliably moved with less power consumption, and the design can be improved. In the present embodiment, in which electricity obtained by solar power generation is stored in a secondary battery 40, the configuration in which the power consumption stays low is beneficial.

The fifth wheel 271 and the third wheel 272 are used in order to increase the deceleration rate, which allows for a smaller size and increased compactness in the planar direction than when only one of these wheels is increased in size and used.

(14) Since the timepiece 1 is driven by electricity from solar power generation, there is no need to replace the battery or to align the pointers with the reference positions as must be done when the battery is replaced, and the need for maintenance can be dispensed with.

(15) Since the date wheel 30 is driven individually via a calendar gear train 33 by a separate calendar drive device 31 from the seconds hand motor 21 and the hour/minute hand motor 26, the time needed to detect the pointer positions can be shortened, the size of the timepiece can be reduced, and the gear trains 22 and 27 can be simplified.

The present invention is not limited to the embodiments previously described, and includes all modifications and improvements within a range in which the objects of the present invention can be achieved.

For example, in the present embodiment, when the power supply voltage is less than the second specific voltage in step S34 of the routine S30 for detecting the pointer position, the range for detecting the pointer positions is reduced, but the cycle of operation for detecting the time display member position may be extended, for example. If the cycle of operation for detecting the time display member position is extended, the power supply voltage easily returns to the original voltage after the voltage degreases as a result of driving the motor or driving the optical sensor, and the decrease in voltage can be reduced accordingly.

Also, the time display members whose position is detected are not limited to the seconds hand 2A, the minute hand 2B, and the hour hand 2C, and may include the date wheel 30 or another calendar time display member. Furthermore, in a timepiece in which chronograph hands, alarm hands for setting the alarm time, or 24 hour hands are provided, these pointers may also have their position detected.

Thus, if other time display members are provided in addition to the pointers 2 for indicating the time, and the power supply voltage is less than the second specific voltage, the number of time display members whose positions are detected may be reduced in comparison with cases in which the power supply voltage is equal to or greater than the second specific voltage. For example, if the power supply voltage is equal to or greater than the second specific voltage, the positions of the date wheel 30 and other various pointers may be detected in addition to those of the pointers 2, and if the voltage is less than the second specific voltage, only the positions of the pointers 2 may be detected. As a result of this configuration, fewer pointer positions are detected than with a relatively low power supply voltage of less than the second specific voltage, making it possible to reduce energy consumption and to minimize the voltage reduction.

Furthermore, in the present embodiment, the seconds hand 2A is driven by the seconds hand reduction gear train 22, and the hour and minute hands 2B and 2C are driven by the hour/minute reduction gear train 27, but another possibility is to drive the seconds hand 2A and the minute hand 2B with a motor by means of a seconds/minute gear train, and to drive the hour hand 2C and the date wheel 30 or another calendar indicating member with another motor by means of an hour/calendar gear train.

Furthermore, when a voltage-enhancing device 490 (voltage-enhancing means) is provided and the power supply voltage is low, the motor or position detector may be driven by increasing the voltage. As a result of this configuration, the motor or the position detector can be reliably driven even when the power supply voltage is low.

In the routine S30 for detecting the pointer position, the routine S30 for detecting the pointer position is ended and the pointers 2 are moved to the current time (internal time) to resume regular pointer movement when the power supply voltage decreases to less than the specific voltage during the pointer position detection routine. Another possibility is to switch to irregular pointer movement or to move the pointers 2 to specific positions, whereby the user is notified that the voltage has decreased, and electricity generation is facilitated. In this case, after the power supply voltage has increased due to electricity generation, the pointers may be moved to the internal time and regular pointer movement may be resumed.

When the power supply voltage decreases to less than the specific voltage during the pointer position detection routine, a reset signal can be output in order to prevent the IC or CPU from operating in a runaway mode, and the IC or CPU may be initialized.

In the routine S30 for detecting the pointer position, the pointers are rotated forward during the hour/minute hand position detection routine (S46) by moving the hour and minute hands 2B and 2C in S45, but the pointer position detection routine may also be performed while rotating the pointers backwards. However, if the pointers are rotated backwards, stable detection may not be possible due to backlash misalignments, and therefore it is preferable to detect the pointer positions while rotating the pointers forward as in the previous embodiment.

Another possibility is to detect the voltage after pointer position detection is complete and before the pointers are moved to the current time display by a motor drive pulse, to move the pointers to the current time display when the voltage is equal to or greater than the specific voltage, and to move the pointers to a display that notifies the user of a voltage drop when the voltage is less than the specific voltage. As a result, the user can perceive that the power supply voltage has decreased to less than the specific voltage due to the pointer position detection routine, and can therefore quickly take the necessary measures, such as replacing or charging the battery or causing electricity to be generated.

In the previous embodiment, the pointer position detection routine is performed when the internal time counter 404 reaches the minute mark, the 0:00 mark, or the 12:00 mark, but the pointer position detection routine may also be performed when the pointer position counter 406 reaches the minute mark, the 0:00 mark, or the 12:00 mark.

Also, in the previous embodiment, the pointer position detection routine is performed if the power supply voltage is equal to or greater than the specific voltage at the minute mark, the 0:00 mark, or the 12:00 mark. Thus, if the power supply voltage is equal to or greater than the specific voltage, then during the power-saving mode, reception mode, or an operating mode other than the regular pointer movement mode in which the pointers are moved by the user, the timepiece may be set so that the pointer position detection routine is not performed when the pointer position counter 406 or the internal time counter 404 reaches the minute mark, the 0:00 mark, or the 12:00 mark.

If the pointer position detection routine is performed during an operating mode other than the regular pointer movement mode, such as the power-saving mode, the radio wave receiving mode, or the manual correction mode, these special operations may be impeded, but if the pointer position detection routine is not performed during these special operating modes, then the special operations can be reliably executed.

Furthermore, when the power supply voltage is less than the specific voltage, the configuration may be designed so that the detection resistor 455 of the phototransistor 452 for detecting the pointer positions is switched to a high detection resistance value, and the sensitivity of the phototransistor 452 is increased to enable faint light to be detected. As a result of this configuration, errors in pointer position detection can be reduced.

Detecting the positions of the hour and minute hands is not limited to only when the internal time counter 404 or the pointer position counter 406 is at the 0:00 or 12:00 mark, and the pointer positions may also be detected every time the hour and minute hands are moved during regular pointer movement. If the settings are designed so that the positions of the hour and minute hands are detected only when the seconds hand is at the 0 seconds mark as in the previous embodiment, the pointer positions may be detected with the timing at which the seconds hand is at the 0 seconds mark. For example, when the hour and minute hands are moved with a drive signal that is output with one pulse per minute, the routine for detecting the positions of the hour and minute hands may be performed in accordance with the pulse output timing, and when the minute hand is moved with a plurality of pulses over a distance corresponding to one minute, the routine for detecting the positions of the hour and minute hands may be performed in a pulse interval in which the seconds hand reaches the 0 seconds mark. Also, with respect to the gear train structure, the pointer positions may be detected every time the hour and minute hands are moved if the positions of the hour and minute hands are detected independently of the seconds hand because of considerations related to the gear train structure.

If the pointer positions are thus detected during regular pointer movement, there is no need to speed up the pointers to perform the position detection routine, and the decrease in power supply voltage resulting from speeding up the pointers can therefore be prevented.

Also, in the previous embodiment, when pointer position detection is performed at the minute mark, the 0:00 mark, or the 12:00 mark and the positions cannot be detected, that is, when the data of the internal time counter 404 or the pointer position counter 406 does not match the actual positions of the pointers 2, the pointer positions are detected by speeding up the pointers 2, but another possibility is to continue regular pointer movement without speeding up the pointers and to search for the pointer positions by detecting the pointer positions whenever the pointers 2 are moved. The position of the seconds hand 2A can then be detected within a maximum of one minute, and the positions of the hour and minute hands 2B and 2C can be detected within a maximum of 12 hours. However, in many cases, the position misalignment of the pointers 2 is not that large, and they can often be detected in a shorter amount of time.

If the pointer positions are thus detected during regular pointer movement, there is no need to speed up the pointers 2 to perform the position detection routine, and decreases in power supply voltage due to increases in the pointer speed can therefore be prevented.

Furthermore, a position may be detected each time the internal time counter 404 or the pointer position counter 406 is within five minutes of the 0:00 mark or the 2:00 mark, that is, within a range in which the pointer position can be detected with a high possibility. In common practice, the position misalignment of the pointers 2 is not overly large, making it highly likely that the positions of the pointers 2 can be detected with each cycle if such a detection is performed in a specific range, there is virtually no need to speed up the pointers to detect their positions, and the decrease in power supply voltage can be suppressed. Moreover, when, for example, the pointer position counter 406 is at 12:00, and the hour and minute hands 2B and 2C are indicating 11:57, the positions of the hour and minute hands in the previous embodiment cannot be detected unless the hour and minute hands are sped up to be near to 12:00 or are moved to the 12:05 mark and then rotated backwards to the 11:55 mark and rotated forward again. However, if the positions of the pointers are detected with every cycle within a preset range, the amount by which the pointers move to perform position detection can be reduced, and the decrease in the power supply voltage during the pointer position detection routine can be suppressed.

Also, if detecting the position of the seconds hand has failed after having been continuously performed a specific number of times, it is highly possible that the timepiece 1 is at a temperature at which the operation of detecting the pointer positions cannot be guaranteed, and therefore the seconds position detection at the minute mark may be stopped and the routine for detecting the position of the seconds hand 2A may be terminated until the next hour mark or another preset time period. Thus, if the seconds hand is detected only at the hour mark or another set timing until the position of the seconds hand 2A is successfully detected, then the problems of wasteful energy consumption can be eliminated.

In the previous embodiment, a timepiece 1 with a radio wave corrective function was described as the electronic apparatus, but the electronic apparatus of the present invention is not limited thereto, and may be a stopwatch, a timer, a pointer-type tester for measuring electrical properties, a pointer-type meter or another measuring device with pointers, or any other electronic apparatus having time display members and a function for detecting the positions of these time display members.

Also, the power supply for the electronic apparatus is not limited to electricity obtained by solar power generation, and may also be electricity produced by a power generator that is driven by an automatic winding mechanism using a rotary spindle, or a power generator driven by mechanical energy stored in a mainspring, and the power supply may also of course be a primary battery.

In the previous embodiment, since the light-receiving element 7 is disposed on the back lid side, manufacturing the back lid from glass or another material that transmits external light allows the external light to enter from an opening in the circuit block 7A or a circuit presser and to sometimes be reflected by the light-receiving element 7. This results in errors in detecting the pointer positions, and in order to prevent such errors, the glass back lid is preferably provided with a light blocking device, and the light blocking device is preferably one that blocks infrared rays most commonly used in LEDs.

In the previous embodiment, the minute hand 2B moves in five-second cycles, but may also be moved in shorter cycles than five seconds, such as two-second cycles, in order to increase the retained torque.

Also, if there is no need to increase the retained torque, the cycle may be 10, 20, or 30 seconds as in the prior art. Such cases are not included in the invention in claim 15, but are included in the inventions of other claims that do not cite claim 15.

As used herein, the following directional terms “forward, rearward, above, downward, vertical, horizontal, below and transverse” as well as any other similar directional terms refer to those directions of a device equipped with the present invention. Accordingly, these terms, as utilized to describe the present invention should be interpreted relative to a device equipped with the present invention.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention. The terms of degree such as “substantially”, “about” and “approximately” as used herein mean a reasonable amount of deviation of the modified term such that the end result is not significantly changed. For example, these terms can be construed as including a deviation of at least +5% of the modified term if this deviation would not negate the meaning of the word it modifies.

This application claims priority to Japanese Patent Application Nos. 2004-344685 and 2004-344502. The entire disclosure of Japanese Patent Application Nos. 2004-344685 and 2004-344502 are hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. An electronic apparatus, comprising:
a first time display member indicating first information;
time display member drive means for driving said first time display member;
voltage detection means for detecting voltage;
time display member position detection means for detecting positions of said first time display member; and
control means for controlling said time display member drive means and said time display member position detection means based on said voltage detected in said voltage detection means.

2. The electronic apparatus according to claim 1, wherein
said control means controls said time display member position detection means to start detecting when said voltage being detected by said voltage detection means is equal to or higher than a first predetermined voltage before said time display member position detection means detects voltage, and said control means controls said time display member position detection means not to detect when said voltage being detected by said voltage detection means is lower than said first predetermined voltage before said time display member position detection means detects.

3. The electronic apparatus according to claim 2, wherein
said control means narrows a detection range of said time display member position detection means when said voltage being detected by said voltage detection means is equal to or high than said first predetermined voltage and lower than a second predetermined voltage that is higher than said first predetermined voltage when said time display member position detection means starts detecting than when said voltage is higher than said second predetermined voltage when said time display member position detection means starts detecting.

4. The electronic apparatus according to claim 2, wherein
said control means lengthens a detection cycle of said time display member position detection means when said voltage being detected by said voltage detection means is equal to or higher than said first predetermined voltage and lower than a second predetermined voltage that is higher than said first predetermined voltage when said time display member position detection means starts detecting than when said voltage is higher than said second predetermined voltage when said time display member position detection means starts detecting.

5. The electronic apparatus according to claim 2, wherein
said control means detects fewer positions when said voltage being detected by said voltage detection means is equal to or higher than said first predetermined voltage and lower than a second predetermined voltage that is higher than said first predetermined voltage when said time display member position detection means starts detecting than if said voltage is higher than said second predetermined voltage when said time display member position detection means starts detecting.

6. The electronic apparatus according to claim 1, wherein
said control means maintains detection by said time display member position detection means when said voltage being detected by said voltage detection means is equal to or higher than a first predetermined voltage while said time display member position detection means detects, and said control means controls said time display member position detection means stopping detecting when said voltage being detected by said voltage detection means is lower than said first predetermined voltage while said time display member position detection means detects.

7. The electric apparatus according to claim 6, wherein
said control means restarts detection by said time display member position detection means when said voltage is higher than said first predetermined voltage after said time display member position detection means stops detecting.

8. The electric apparatus according to claim 6, wherein
said control means narrows a detection range of said time display member position detection means when said voltage being detected by said voltage detection means is equal to or higher than said first predetermined voltage and lower than a second predetermined voltage that is higher than said first predetermined voltage when said time display member position detection means starts detecting than when said voltage is higher than said second predetermined voltage when said time display member position detection means starts detecting.

9. The electronic apparatus according to claim 6, wherein
said control means lengthens a detection cycle of said time display member position detection means when said voltage being detected by said voltage detection means is equal to or higher than said first predetermined voltage and lower than a second predetermined voltage that is higher than said first predetermined voltage when said time display member position detection means starts detecting than when said voltage is higher than said second predetermined voltage when said time display member position detection means starts detecting.

10. The electronic apparatus according to claim 6, wherein
said control means detects fewer positions when said voltage being detected by said voltage detection means is equal to or higher than said first predetermined voltage and lower than a second predetermined voltage that is higher than said first predetermined voltage when said time display member position detection means starts detecting than when said voltage is higher than said second predetermined voltage when said time display member position detection means starts detecting.

11. The electric apparatus according to claim 1, further comprising
a battery, wherein
said voltage detection means detects battery voltage of said battery.

12. The electric apparatus according to claim 11, further comprising
generation means, wherein
said battery is charged by said generation means.

13. The electric apparatus according to claim 11, further comprising
voltage enhancing means for increasing said battery voltage supplied from said battery, wherein
said control means controls said voltage enhancing means based on said battery voltage.

14. The electric apparatus according to claim 1, wherein
said control means includes
internal time counter means for timing internal time data and outputting said internal time data,
drive signal generation means for outputting a drive signal to said time display member drive means to drive said first time display member,
time display member position detection means for obtaining time display member position data by counting said drive signal, and
adjustment means for comparing said internal time data and said time display member position data and adjusting said first time display member when said internal time data and said time display member position data do not match.

15. The electric apparatus according to claim 1, wherein
said time display member position detection means includes a first light emitting element and first light receiving element receiving a first light from said first light emitting element.

16. The electric apparatus according to claim 15, wherein
said time display member drive means includes
a first motor having a first rotor pinion,
a first gear train having
a first wheel engaged with said first rotor pinion,
a second wheel engaged with said first time display member, and
a third wheel engaged with said first wheel and second wheel.

17. The electric apparatus according to claim 16, wherein
said first rotor pinion has eight leaves or more.

18. The electric apparatus according to claim 16, wherein
each of said first, second, and third wheels has a first, second, and third detection hole arranged to allow said first light pass through said first, second, and third detection holes.

19. The electric apparatus according to claim 17, further comprising
a second time display member indicating second information different from said first information and being driven by said time display member drive means, wherein
said time display member position detection means includes a second light emitting element and a second light receiving element receiving said second light from said second light emitting element.

20. The electric apparatus according to claim 19, wherein
said time display member drive means includes
a second motor having a second rotor pinion, and
a second gear train having
a fourth wheel configured on the same axis with said second wheel, engaged with said second time display member, and having a fourth detection hole, and
a fifth wheel engaged with said second rotor pinion and said fourth wheel, and having a fifth detection hole.

21. The electric apparatus according to claim 20, wherein
said second gear train includes a sixth wheel engaged with said fourth and fifth wheel, having a sixth detection hole allowing said second light that has passed thorough said fifth detection hole to pass through between said second light emitting element and said second light receiving element.

22. The electric apparatus according to claim 19, further comprising
a third time display member indicating third information different from said first and second information, being driven by said time display member drive means, wherein
said time display member drive means includes
a minute wheel being engaged on the same axis with said second wheel,
an hour wheel being engaged with said third time display member, having a seventh detection hole overlapping said first, second, third, and fourth detection holes.

23. The electric apparatus according to claim 22, wherein
said first time display member is a minute hand, said second time display member is a minute hand, and said third time display member is an hour hand.

24. The electric apparatus according to claim 23, wherein
said minute hand is driven in a five-second cycle or less.

25. A control method for driving an electric apparatus, comprising:
indicating information;
driving said indicating information;
detecting voltage;
detecting positions of said indicating information; and
controlling said driving and said detecting based on said voltage being detected by said detecting voltage.

26. A control program of an electric apparatus having a battery and a time display member showing information, said control program comprising:
time display member drive means for driving said time display member;
voltage detection means for detecting voltage;
time display member position detection means for detecting positions of said time display member; and
control means for controlling said time display member drive means and said time display member position detection means based on said voltage detected in said voltage detection means.

27. A recording medium for a control program, in which said drive control program according to claim 26 is recorded in a format that can be read by a computer.
